(19) United States
(12) Patent Application Publication
(10) Pub. No.: US 2007/0203776 A1
(43) Pub. Date: Aug. 30, 2007

(54) Method of displaying resume over the internet in a secure manner

(76) Inventors: David J. Austin, Philadelphia, PA (US); David C. Carroll, Tabernacle, NJ (US); Robert J. Blacka, Port Saint Lucia, FL (US)

Correspondence Address: Donald C. Simpson, Esquire, 126 Borton Landing Road, Moorestown, NJ, 08057-3055, US

(21) Appl. No.: 11/396,750

(22) Filed: Apr. 3, 2006

Related U.S. Application Data
(63) Continuation-in-part of application No. 11/319,887, filed on Dec. 28, 2005, now abandoned.

(51) Int. Cl. G05B 19/418

(52) U.S. Cl. 705/8

(57) ABSTRACT

A method and apparatus for storing a resume on a server which is part of a computer network (e.g. the Internet), providing a method for the owner of the resume (job candidate) to mask out certain confidential information (such as the owner's identity) while maintaining the “look and feel” of the original resume, and allowing users on the network the freedom to peruse an exact copy of the resume at will, while keeping the confidential parts (e.g. the owner's identity and current employer) sufficiently blurred out that they would be undecipherable. This system would also provide for a method in which any user on the network (i.e. the Internet) who wanted to view the unmasked version of the resume would be granted the ability to send a confidential request directly to the owner of the resume (job candidate) over an Internet-based application for permission to view the entire (unmasked) resume. The system would further provide for a method in which the owner of the resume would be informed of the requests through the internet application and given the identity of the requesters (employers). The owner then would be provided with a method to either approve or deny the requests to view the unmasked resume. The requestors (employers) would then be notified over an Internet link of the approval or denial. The purpose and goal of this invention is to grant the owner of the resume (job candidate) absolute control over who could and who could not view the unmasked version of the resume (which might be his identity and other pertinent personal information) while at the same time allowing users on the network the ability to peruse an exact copy of the resume with the confidential parts rendered indecipherable. A key feature of this invention is that all the back office work of sorting, categorizing, and searching of the resumes including the billing of clients would be handled by an automated computer program with minimal to no human involvement. While this invention is primarily concerned with the storage, retrieval, and display of resumes, it could equally be used for financial reports, medical reports, bank accounts, stock quotes, benefit plans, or any other case where the “look and feel” of the original document is desired to be preserved while masking out the confidential parts of the document in such a manner that the document owner has absolute control over who is able to view the unmasked version of the document.

### RELATED APPLICATIONS

This application is a continuation-in-part of U.S. patent application Ser. No. 121/319,887 filed Dec. 28, 2005.

### FEDERALLY SPONSORED RESEARCH

This invention was not the subject of any federally sponsored research or development.

### FIELD OF THE INVENTION

This invention relates to the field of Internet Commerce where computers are used to list, buy, and sell resumes over the Internet.

### BACKGROUND OF THE INVENTION

The listing of resumes on the Internet has been routine almost as long, as the Internet has been in service, in fact, it is a natural and useful application of the Internet. The Internet is especially conducive to sharing resumes because it consists of hundreds of millions of computers throughout the world interconnected through a vast network that allows them to share information on a scale never before possible. This huge potential for bringing people together has not gone unnoticed and currently there are numerous Internet sites that are devoted to listing resumes.

However, there are a number of problems with the current embodiment of the practice that leaves virtually all of them with a number of serious deficiencies. As a result, the full potential of this Internet application has largely gone unrealized. Many companies and recruiters have recently reduced their dependency upon Internet resume listing services due to these deficiencies and resorted back to more conventional methods of finding suitable employees. There are a number of reasons for this which will be discussed in the following sections.

### DESCRIPTION OF THE PRIOR ART

The Internet is teaming with websites that deal with the storage, retrieval, and display of resumes. In a typical example, the job candidate opens an account, fills in some text boxes with pertinent personal information, then uploads his resume to the hosting website where it is stored on a server along with the pertinent personal information. Some websites vary from this basic format by requiring more or less information, but by and large, the basic functions remain essentially the same. For instance, some websites require the job candidate to fill in some supplementary text boxes with additional job-related information such as job title, experience, education, salary requirements, etc. while others rely entirely on the text boxes and do not allow the uploading of the actual resume. Still others rely entirely on the uploaded resume and require no additional information. Fundamentally, these all serve the same purpose of storing a resume (or the equivalent of a resume) on a computer server and make it available to employers to look at for a fee.

Typically, to use the service, an employer opens an account, pays (or agrees to pay) a fee, then is permitted to enter some search terms to narrow down his search to an applicable job candidate. The server then uses the search terms to search through the database to locate the best match to the employer's criteria. Unfortunately, the accuracy of locating job candidates with the required set of skills using this basic method of randomly searching for keywords has a reputation of being fairly poor. This is because many English voids and abbreviations are spelled alike but mean different things based on the context of the sentence. The search engine is often fooled by look-alike words thus giving mainly false positives.

Many websites have attempted to circumvent these limitations with creative “workarounds” but even with these, the results are less than ideal. For instance, U.S. Pat. Nos. 5,758,324, 6,564,118, 6,718,340, and 6,718,345 acknowledge the problem of storing and searching through thousands of resumes for job candidates without generating false matches to an employer's search requirements. These patents acknowledge that there is value in preserving the “look and feel” of the original document but go into great detail explaining why the current technology does not allow for accurate searches for specific key words on an original text document. Their solution is creative but differs from the current invention in several significant ways.

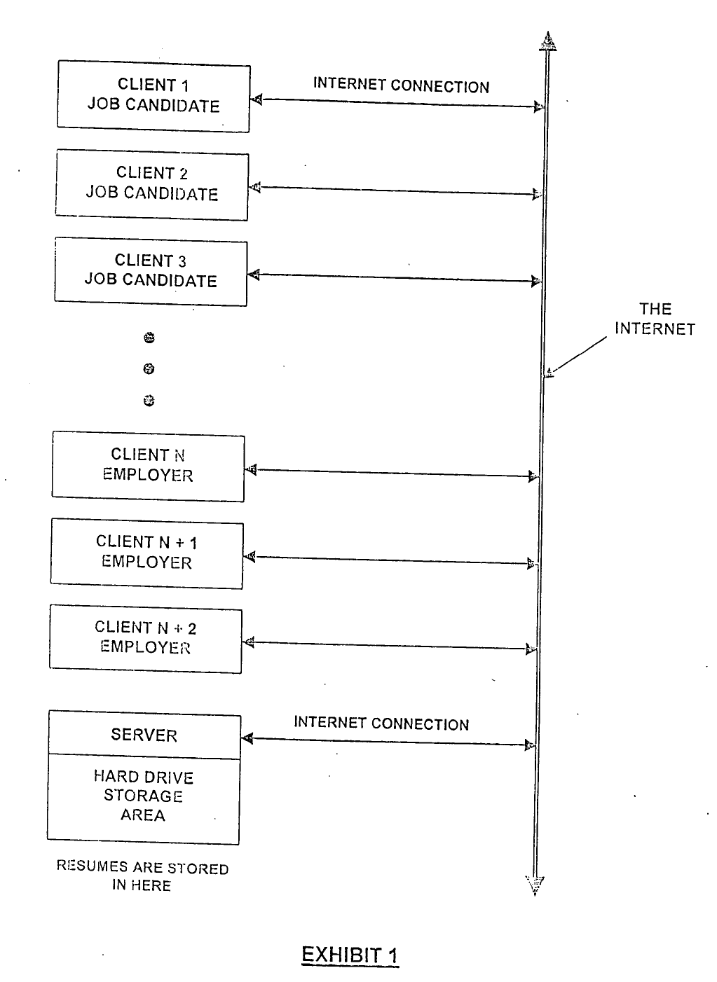

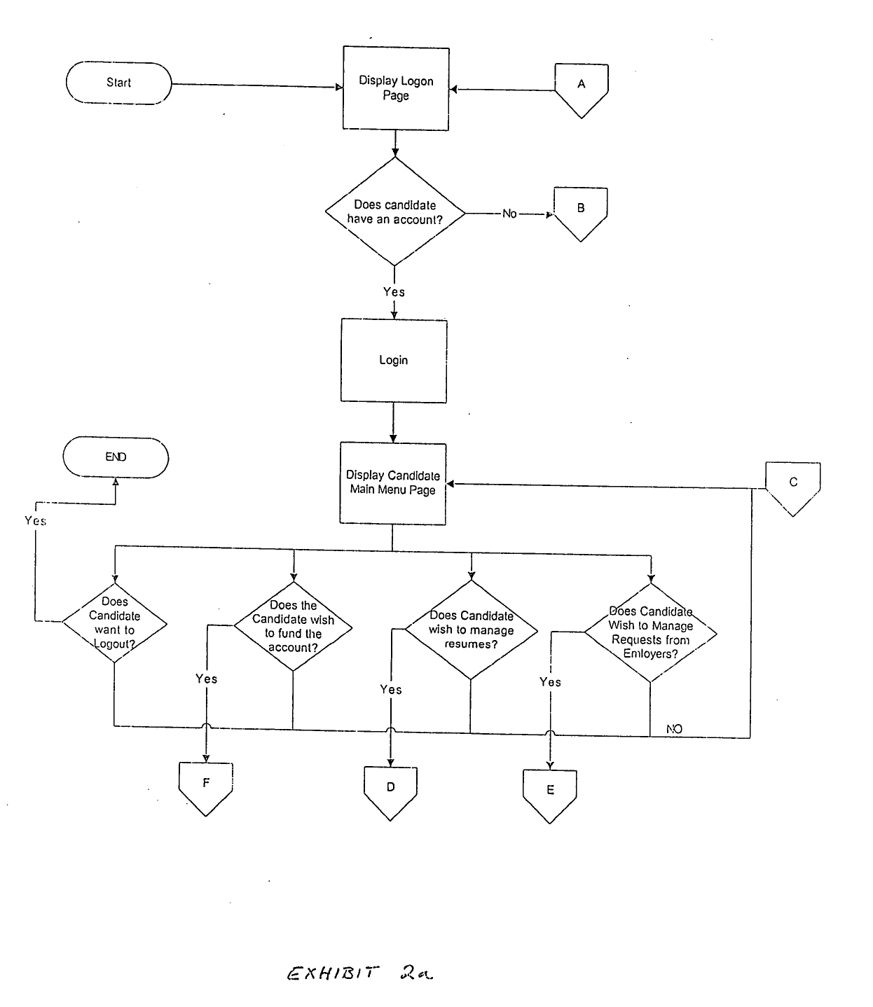

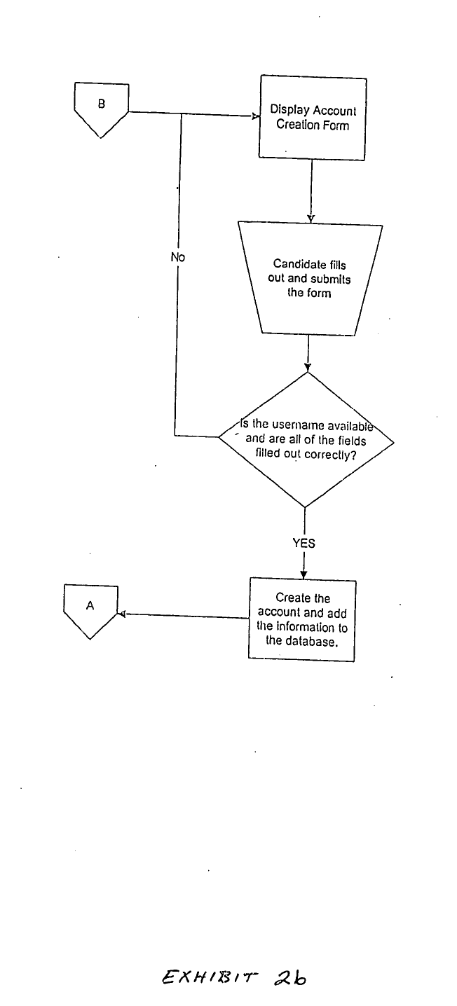

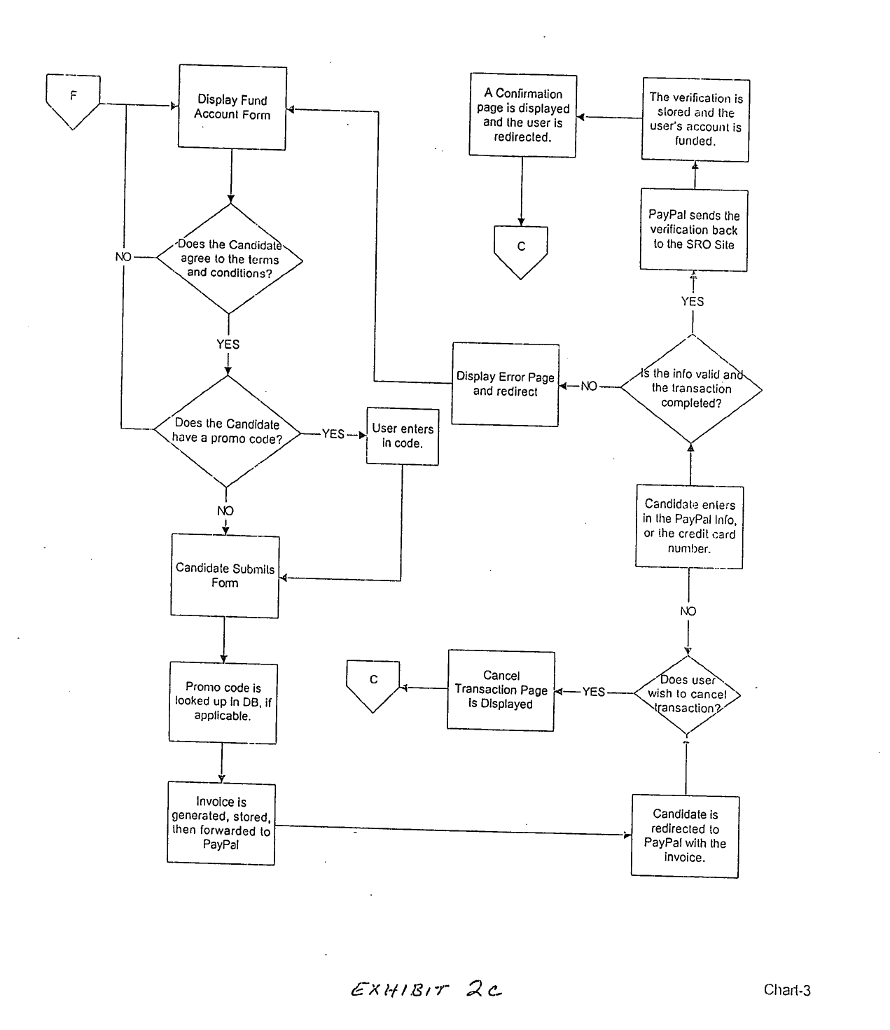

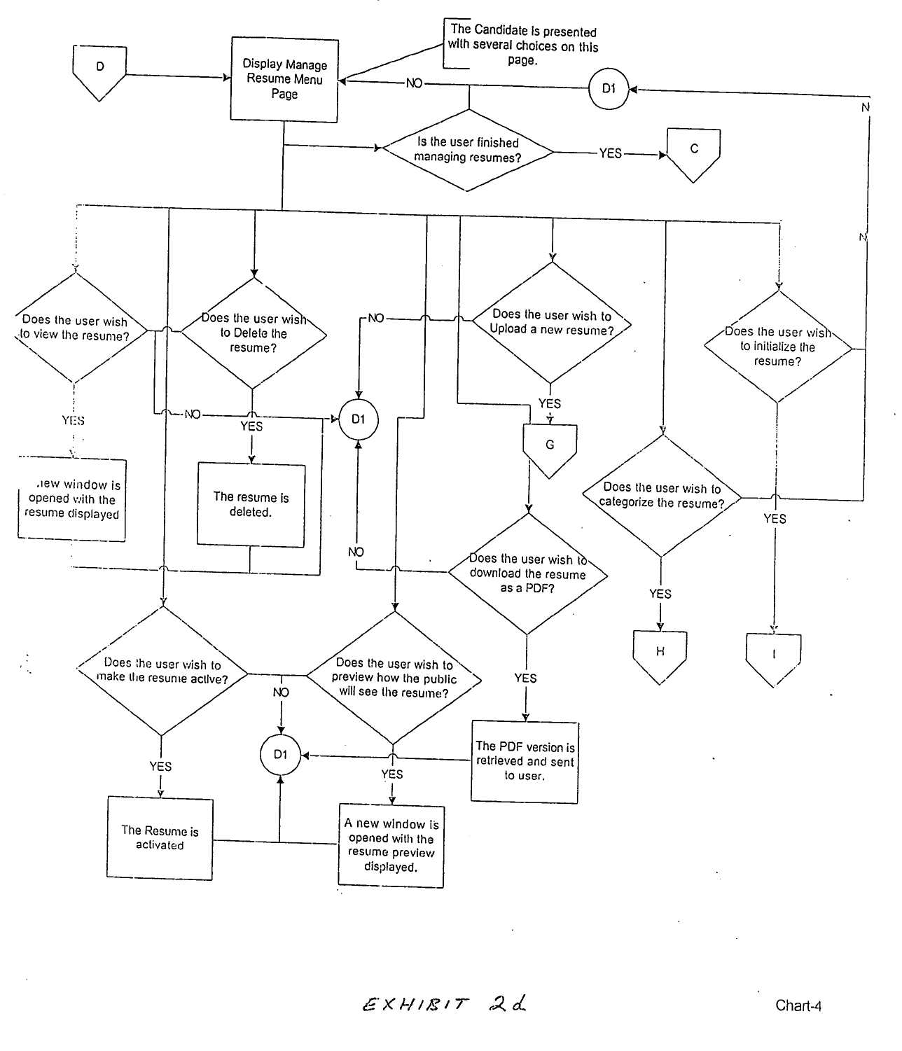

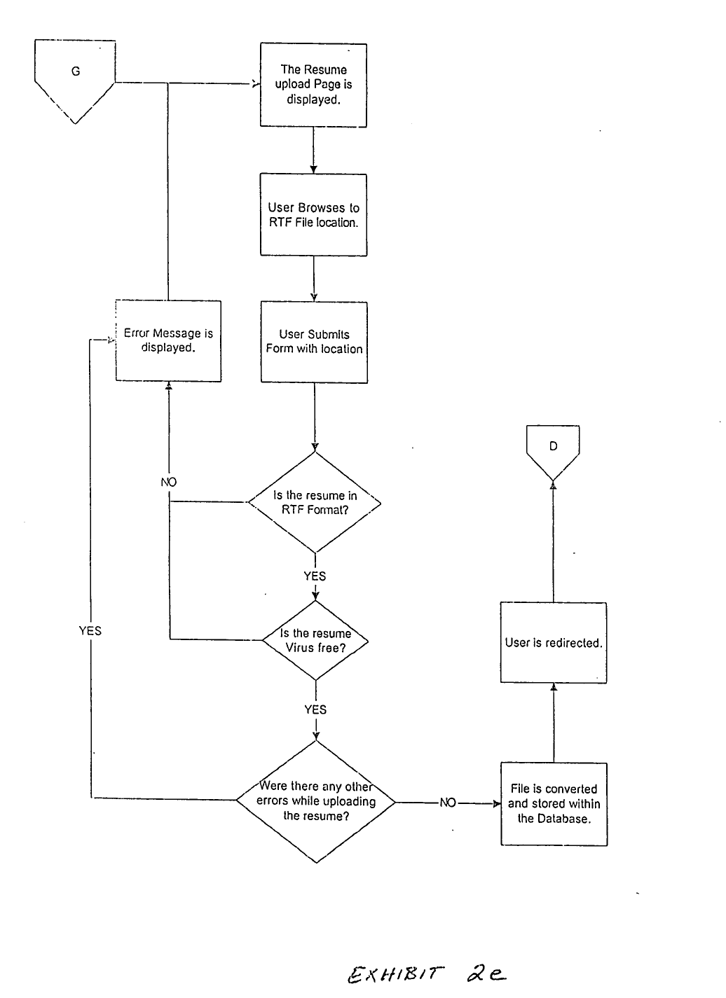

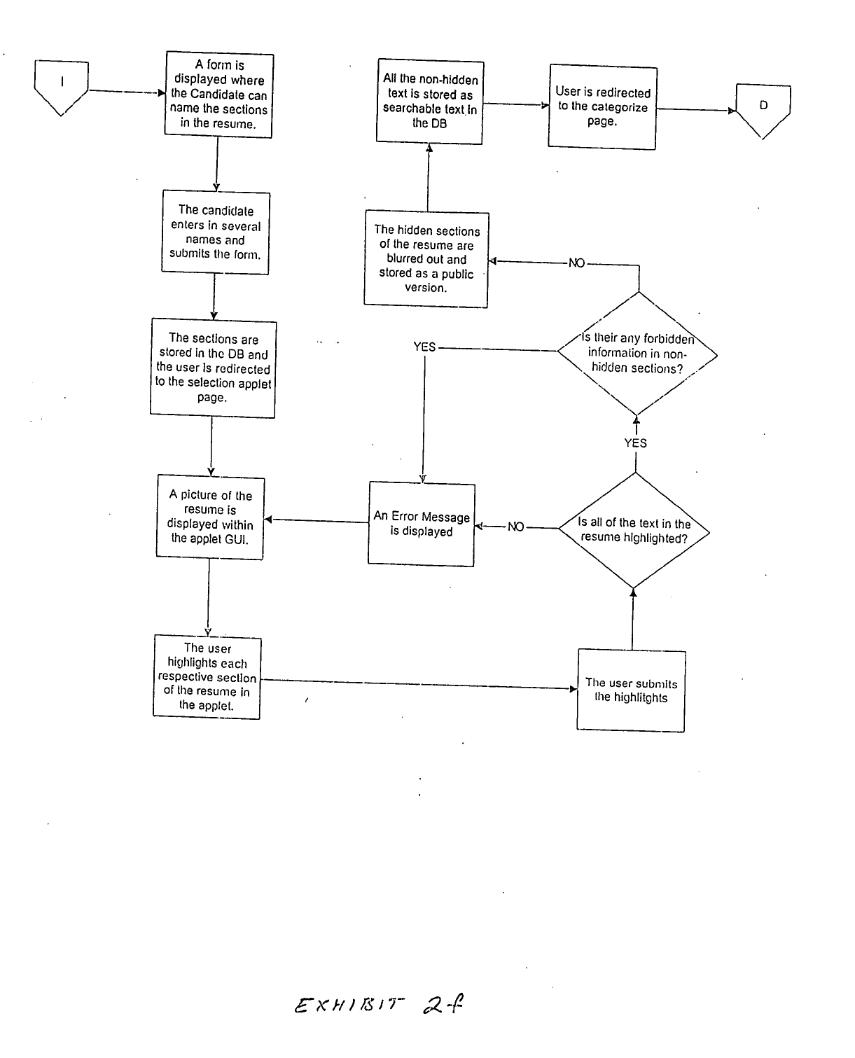

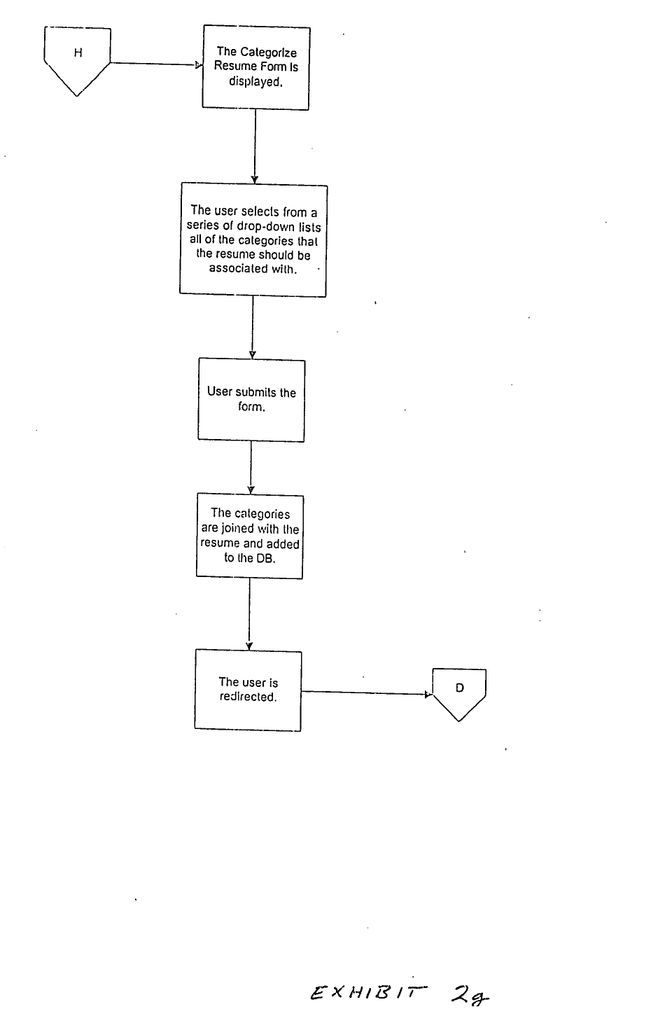

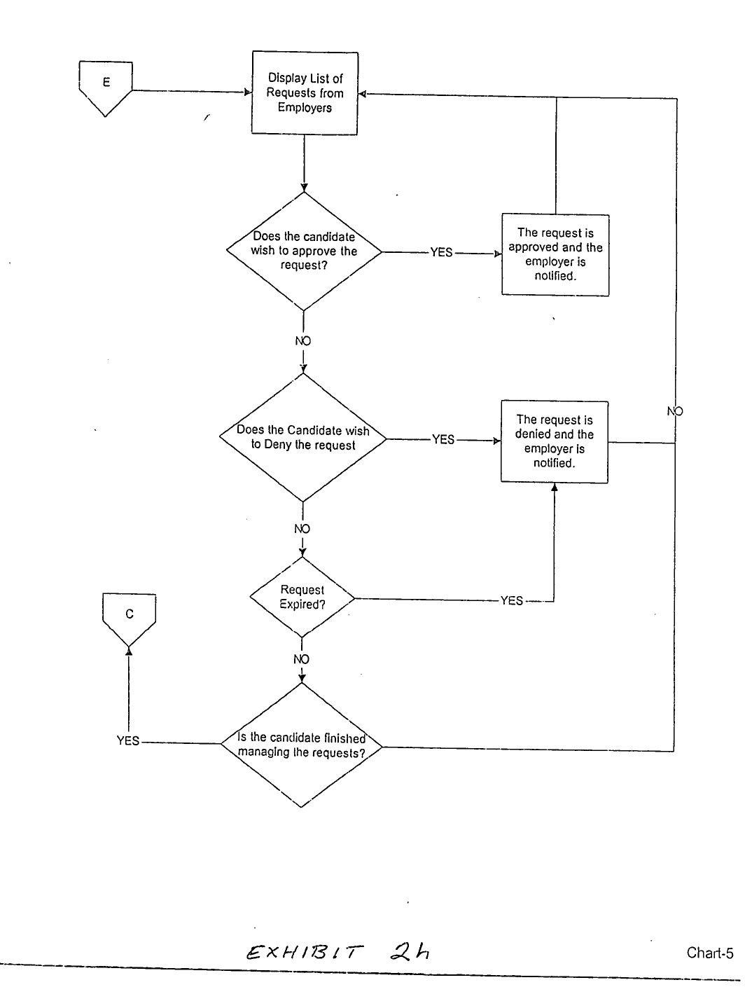

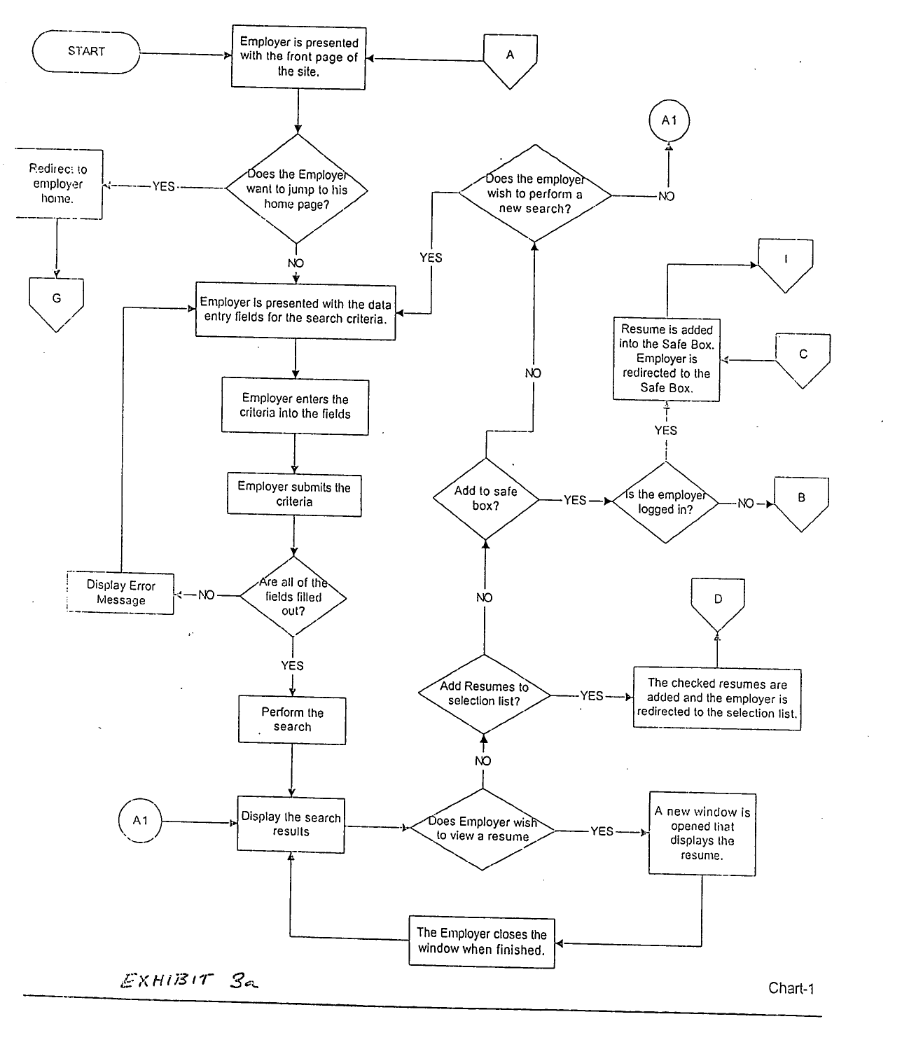

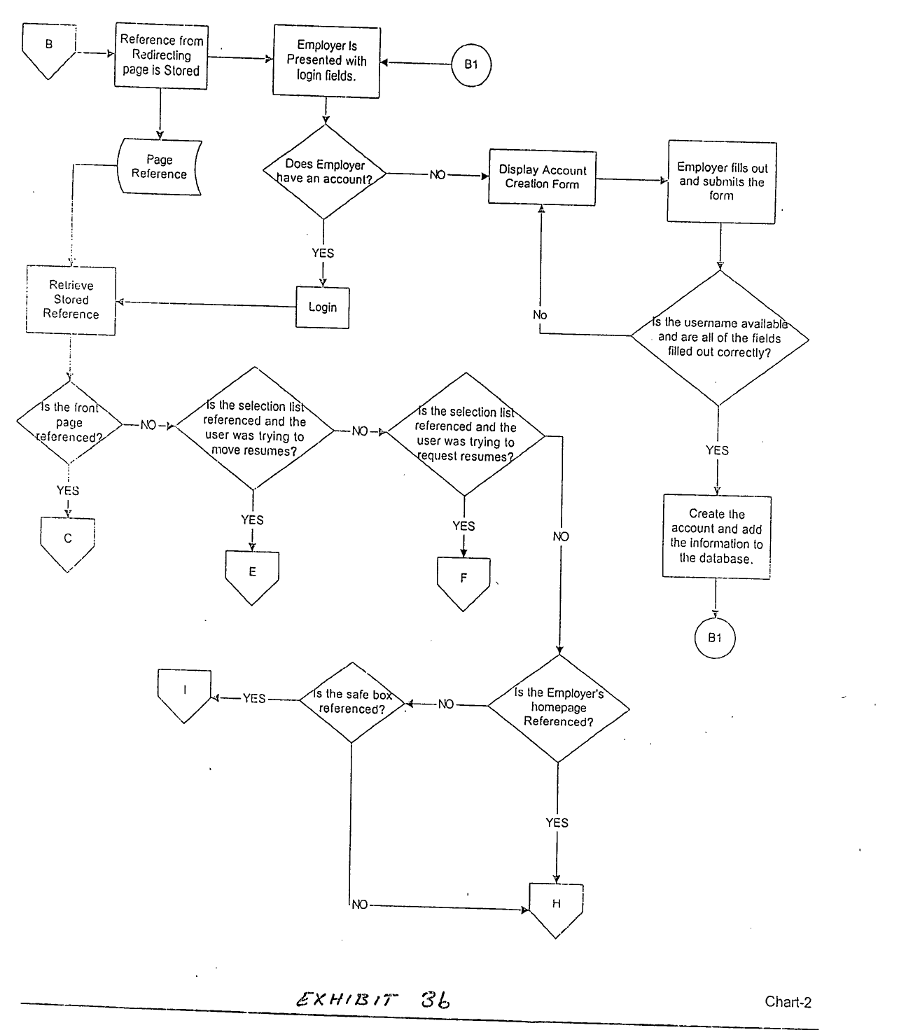

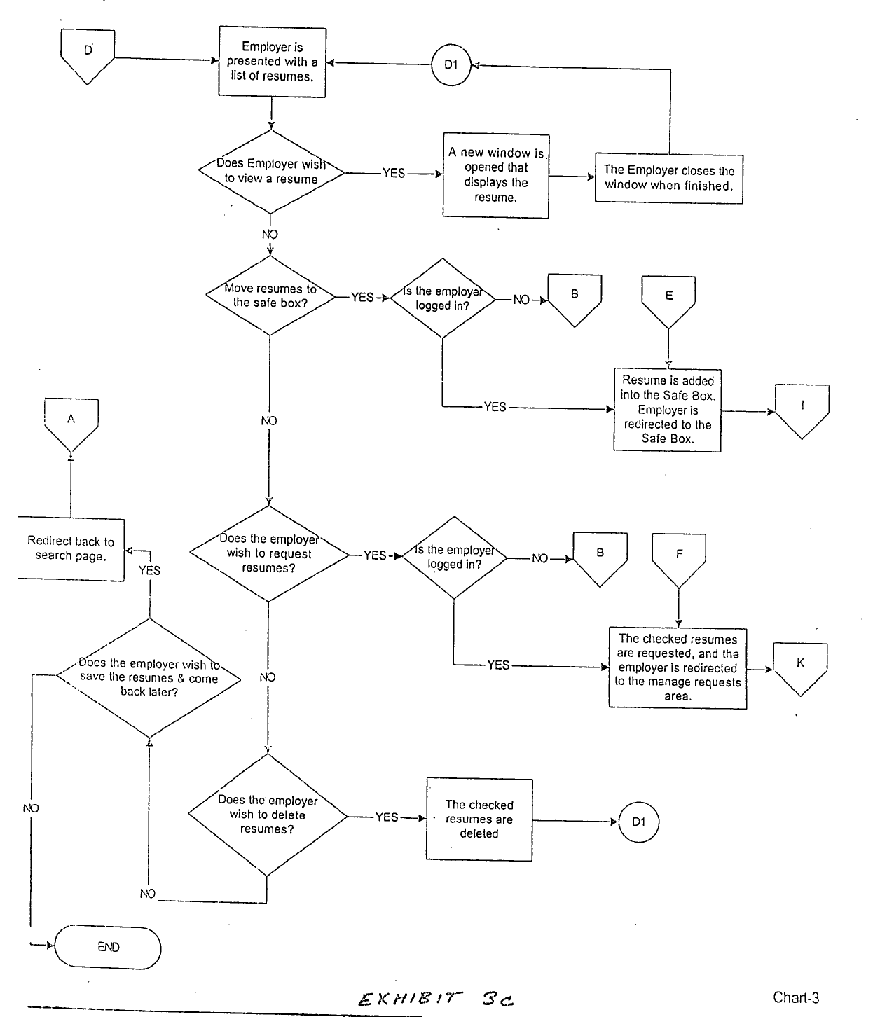

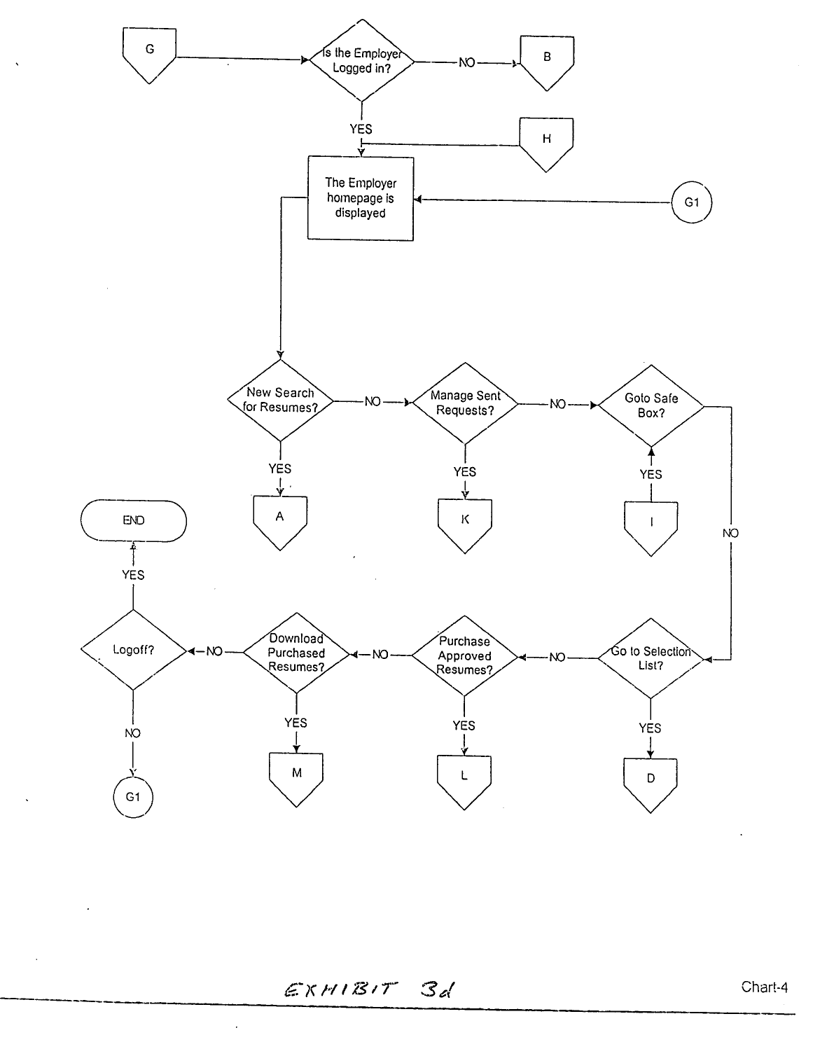

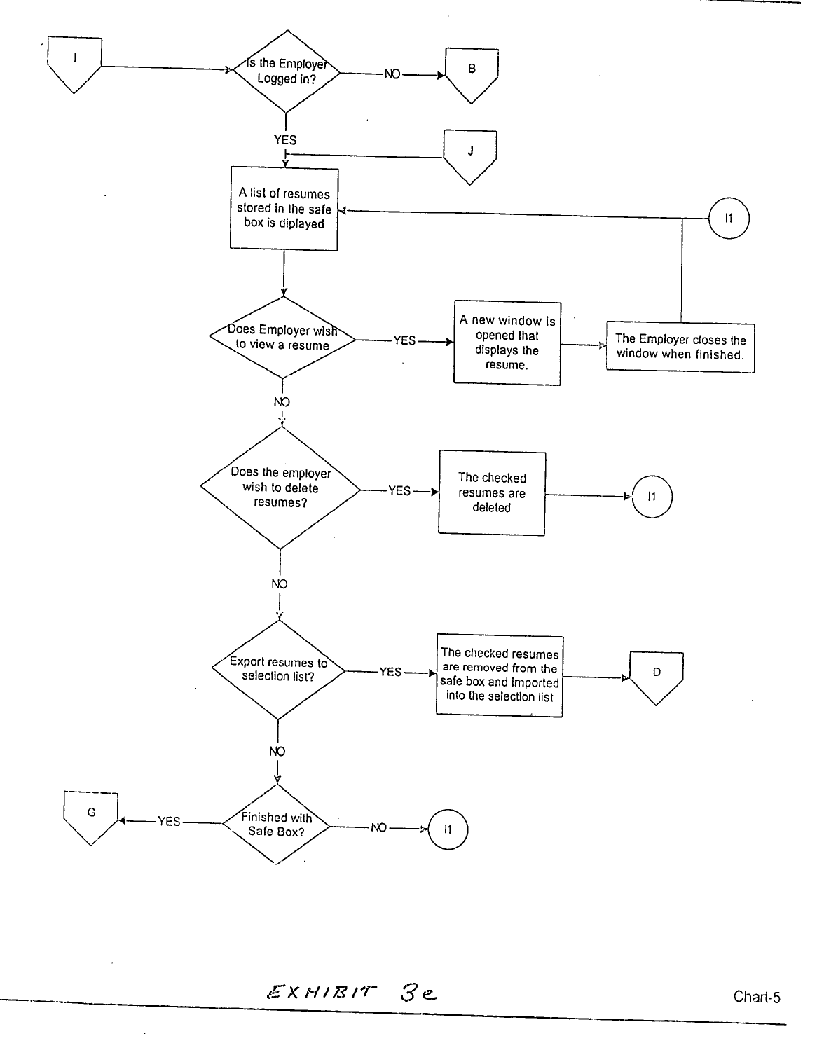

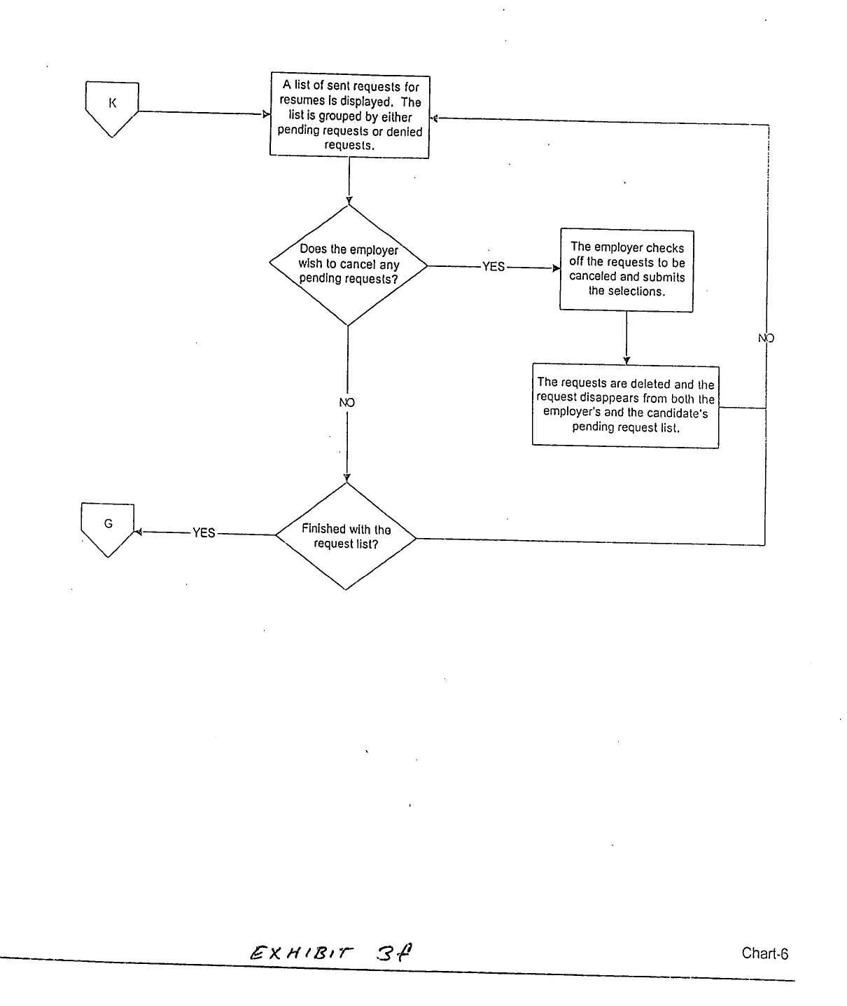

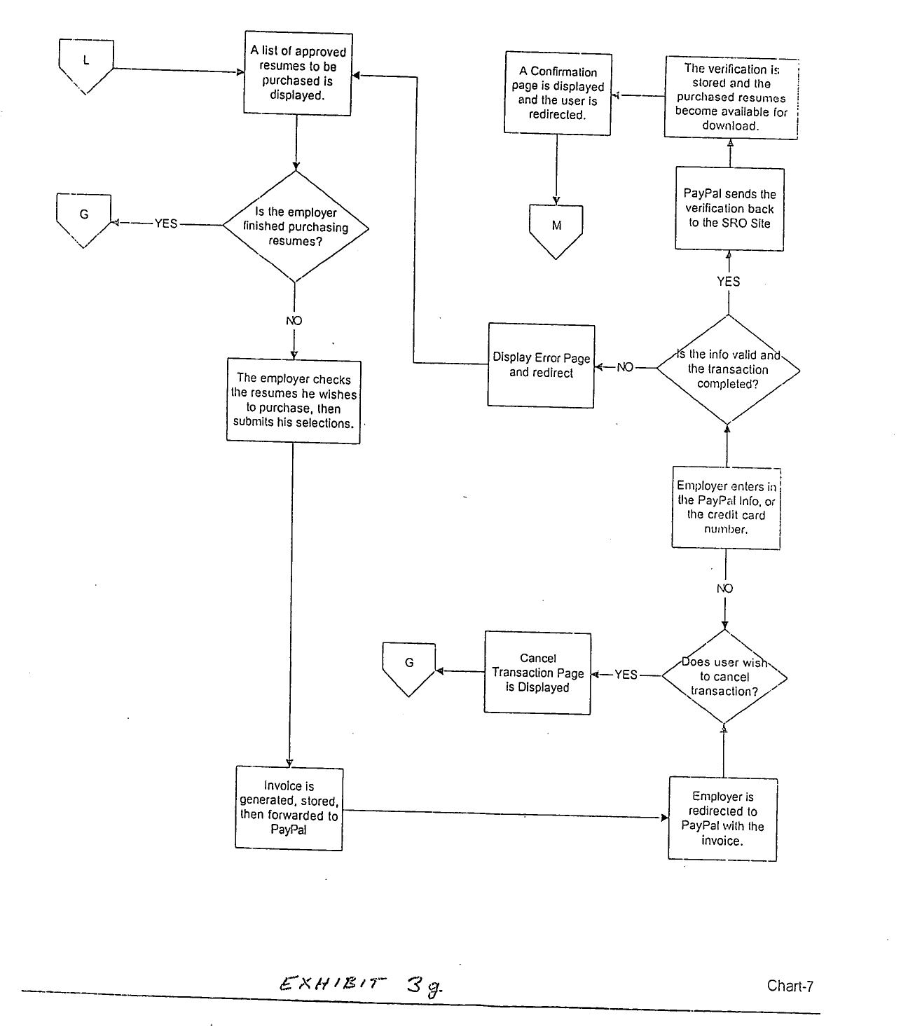

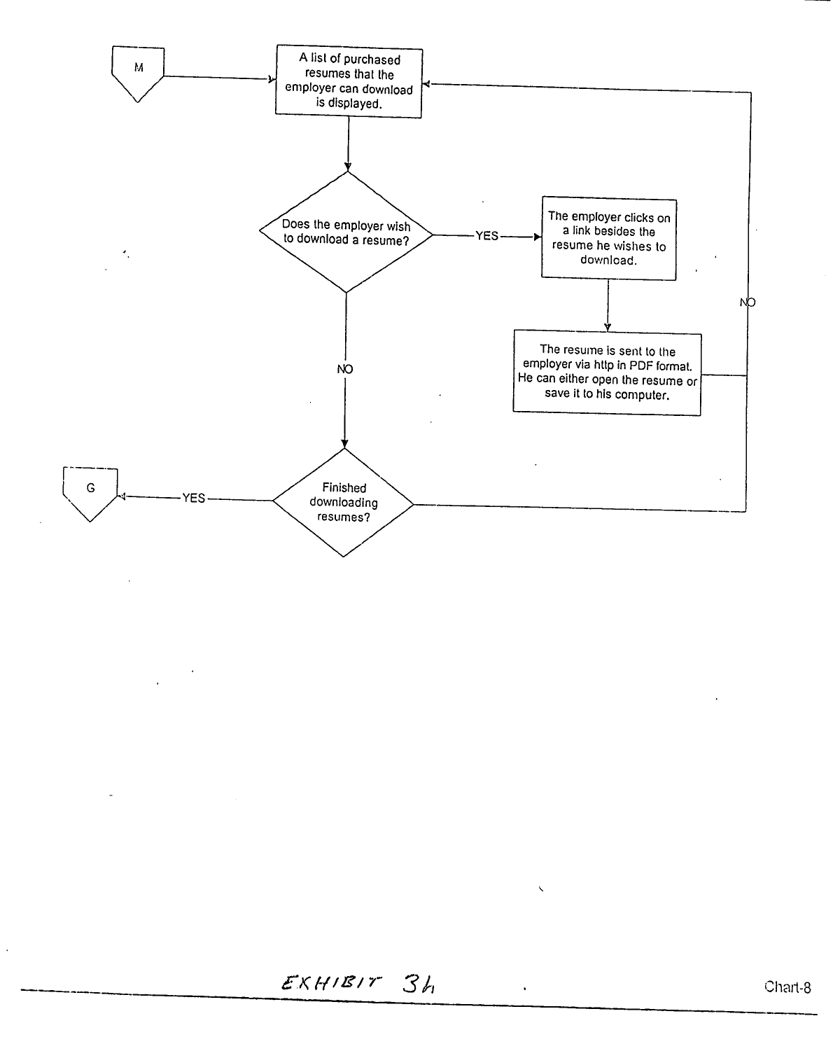

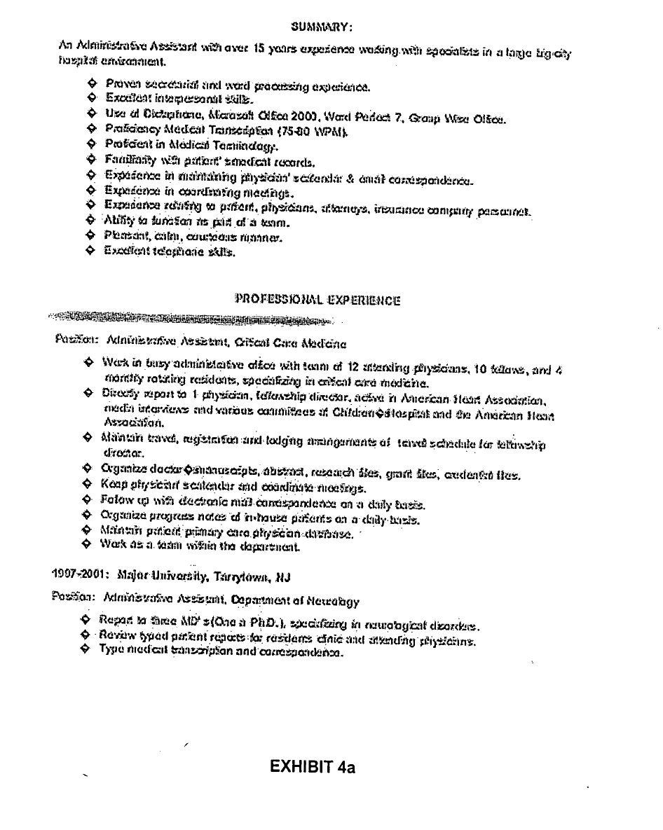

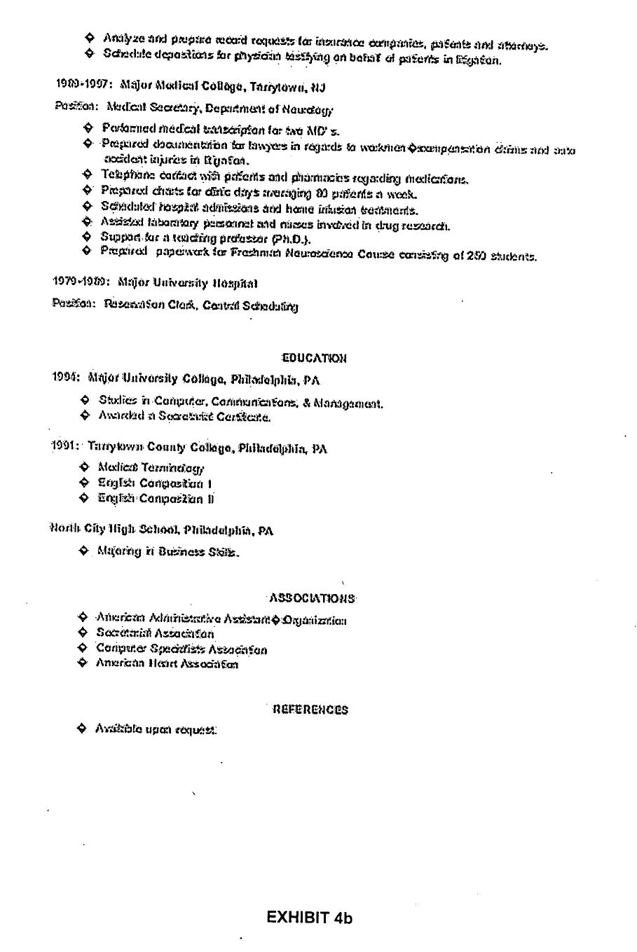

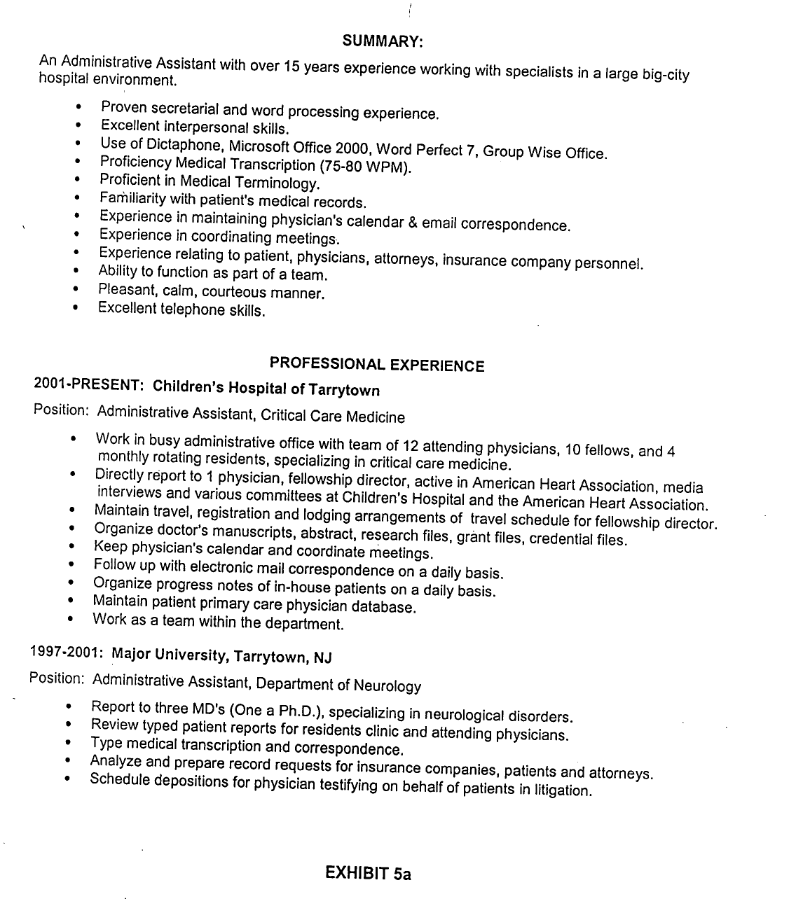

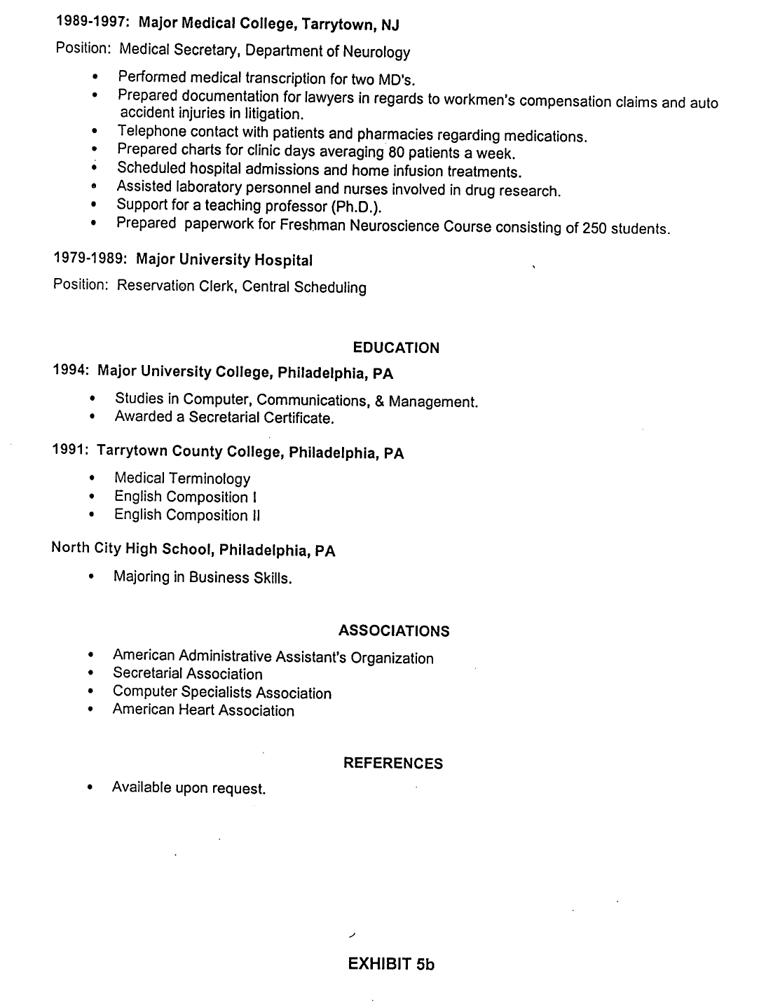

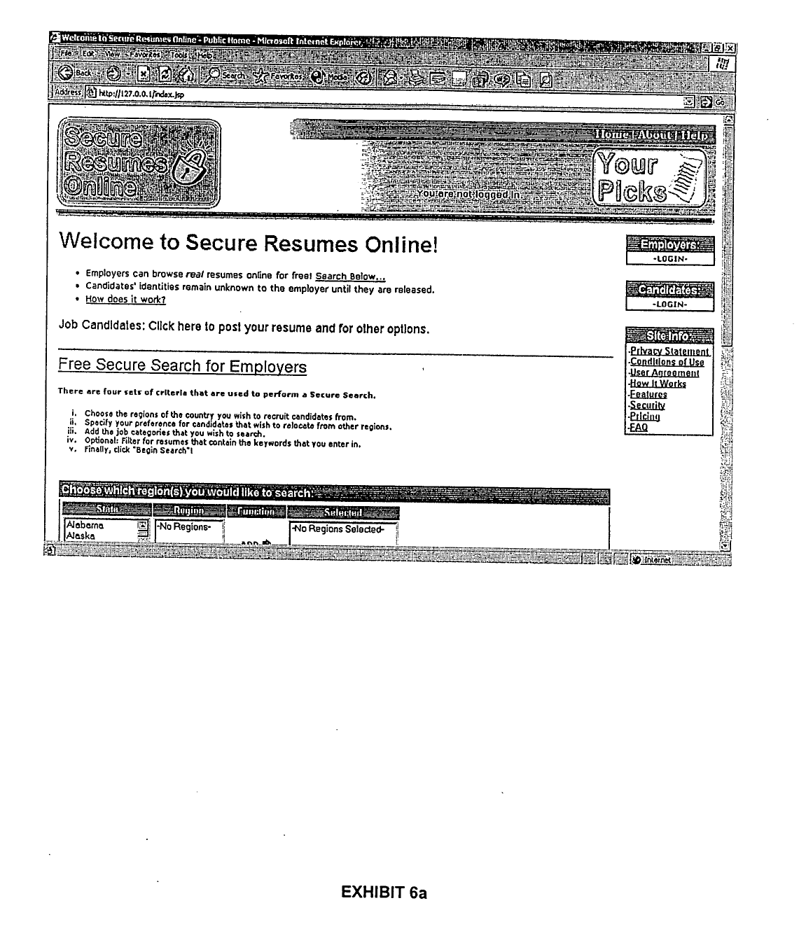

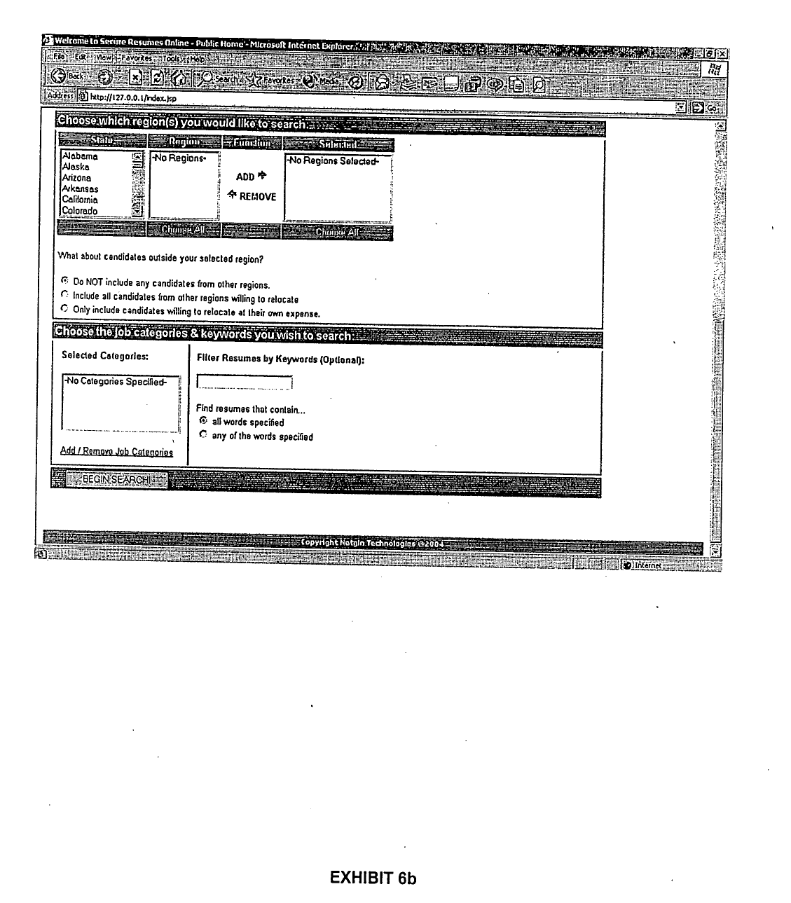

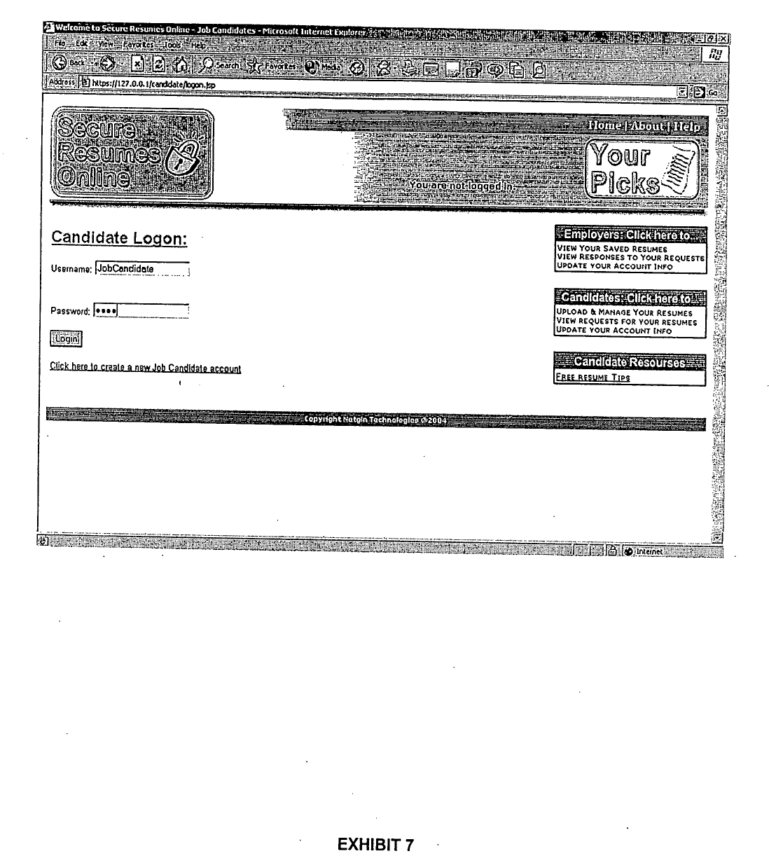

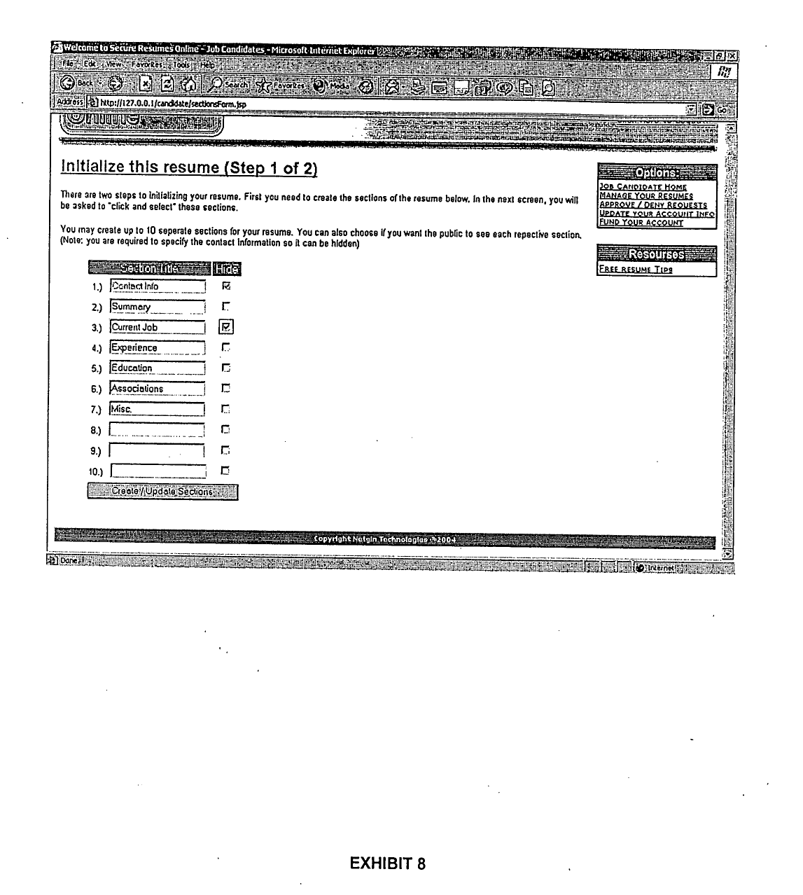

First, the four patents listed above all require the job candidate to fill out all electronic resume outline form consisting of pertinent personal information including mandatory contact information. The outline form is stored along with an electronic image of the resume on a server where the two are linked together. The employer is then required to fill out a search request form and the server searches the database field by field looking for an appropriate match. This is really just an electronic version of the paper file system that has been in use for decades by most employment agencies. The electronic image of the resume is not involved in the search at all and the above-mentioned patents explain in detail why they do not perform a search on the image. In fact, the patents state: “The form is useful in that it provides searchable information. The information of the graphics file cannot be easily searched”. They go on to state: “the form is of a format known to both applicants and employers”. The forms are depicted in U.S. Pat. No. 6,718,345 as FIGS. 3, 4, and 5. In contrast, the current invention searches for keywords directly on the uploaded resume which is stored in an industry standard text format.

Second, in the current invention there is no necessity for requesting and storing the job candidates name, address, or phone number. This is a mandatory requirement in the prior art because they have no way of extracting that information from the stored image of the resume. In the current invention, the only contact information we require is an email address and a PAYPAL account number both of which could be anonymous. In fact, we have no interest in knowing who the individual is at all. This enhances security since there is no need to send this information separately over the Internet or bearing the responsibility of storing it on a server in a secure manner.

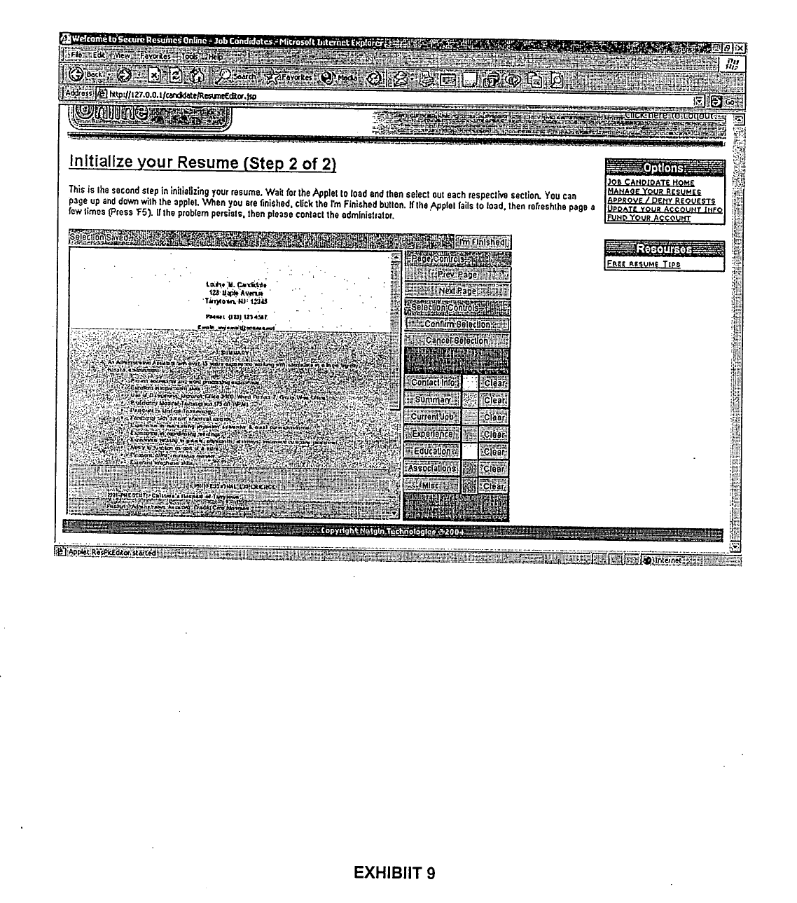

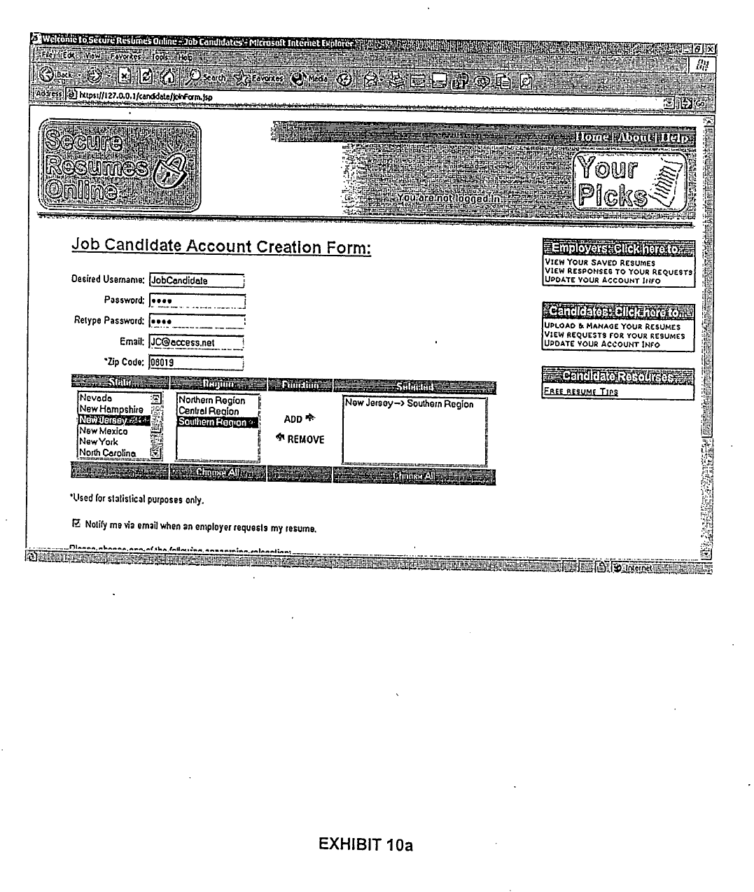

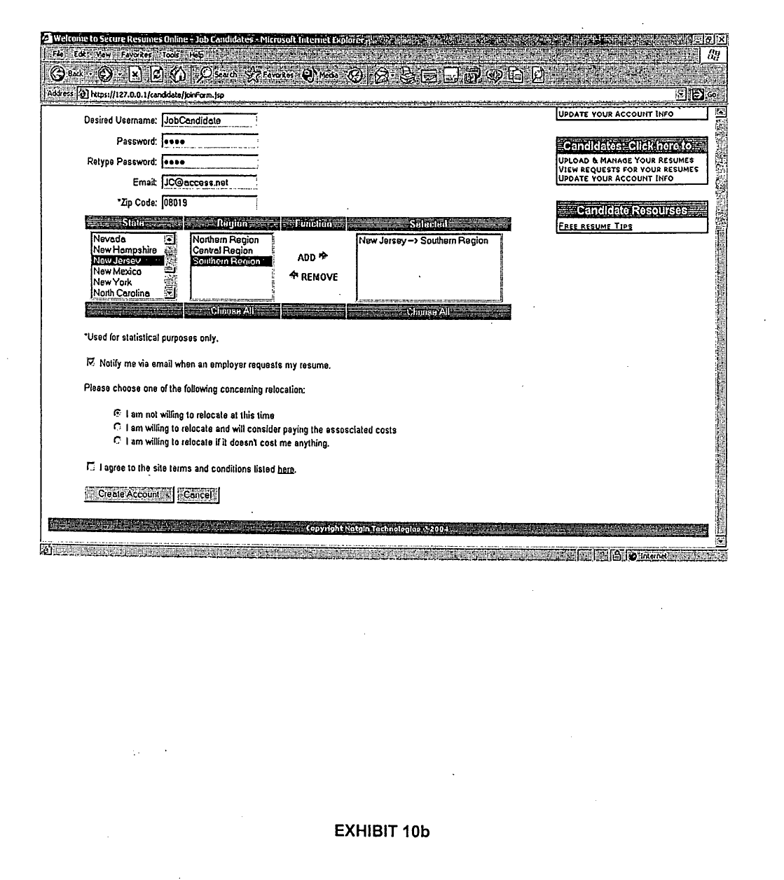

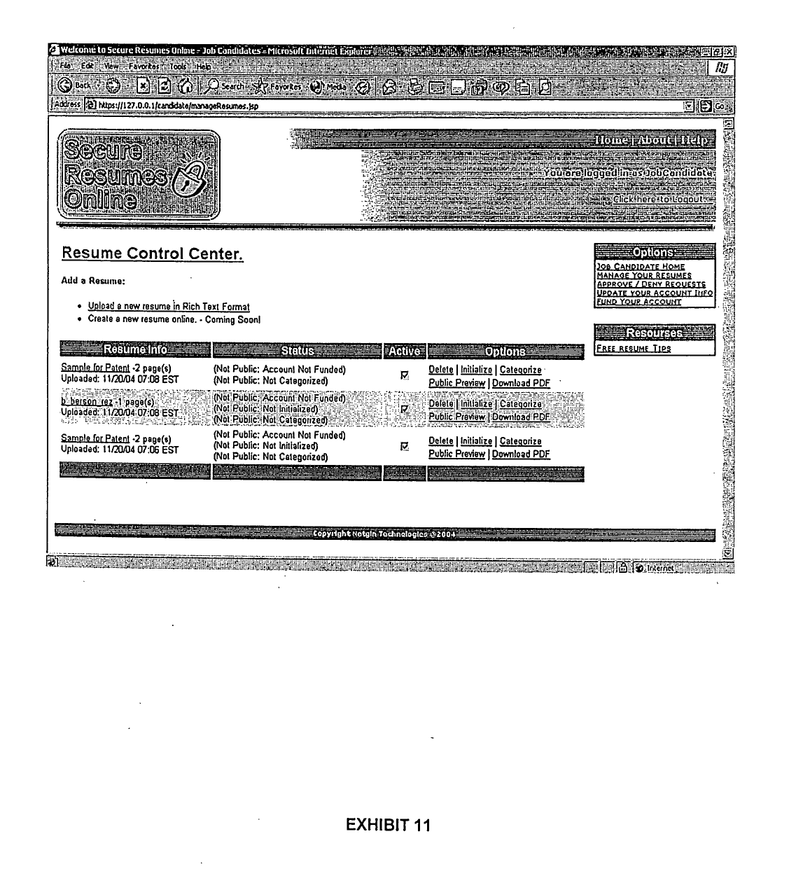

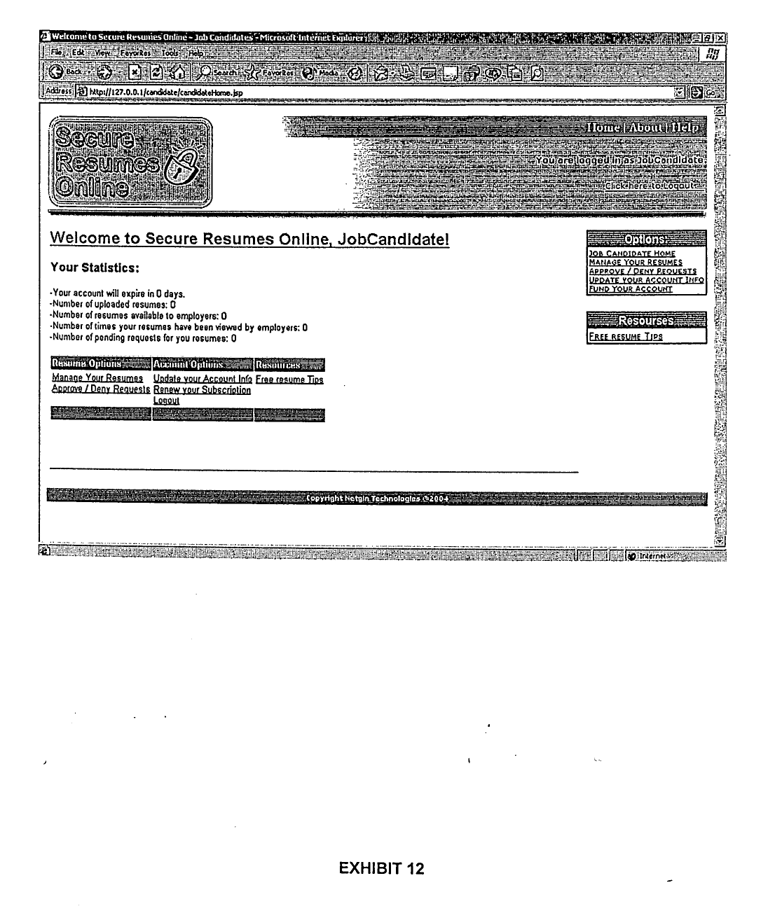

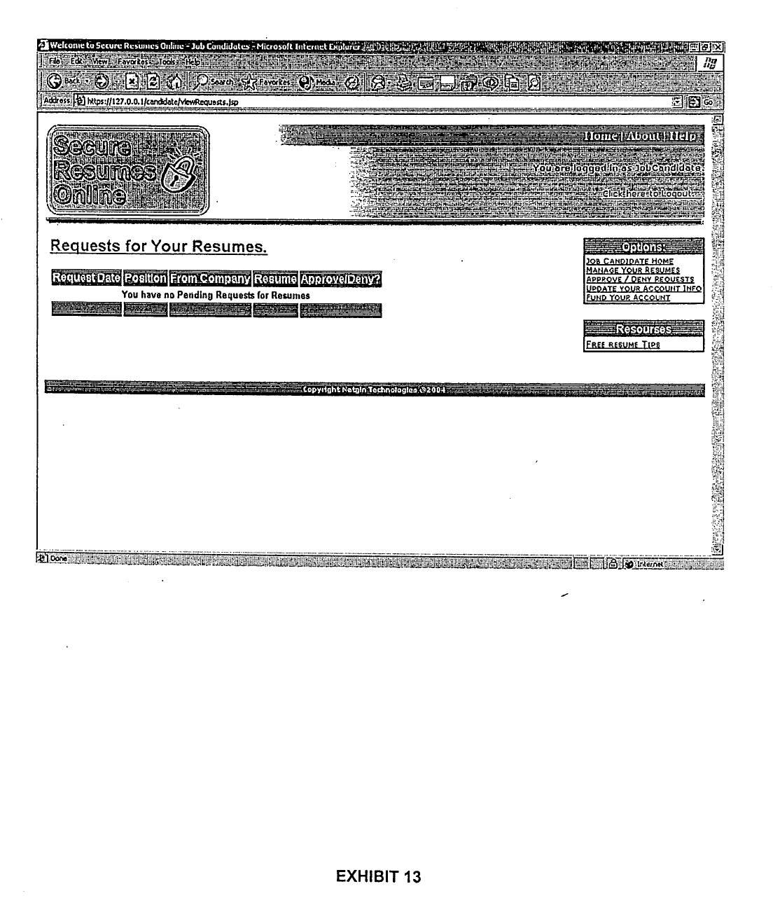

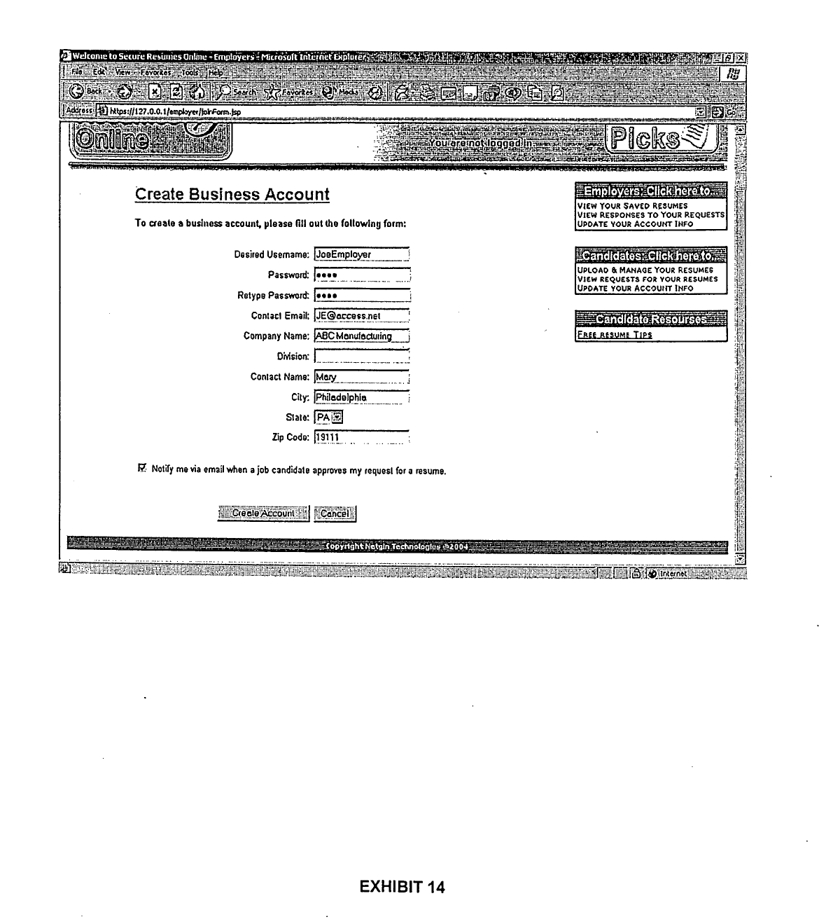

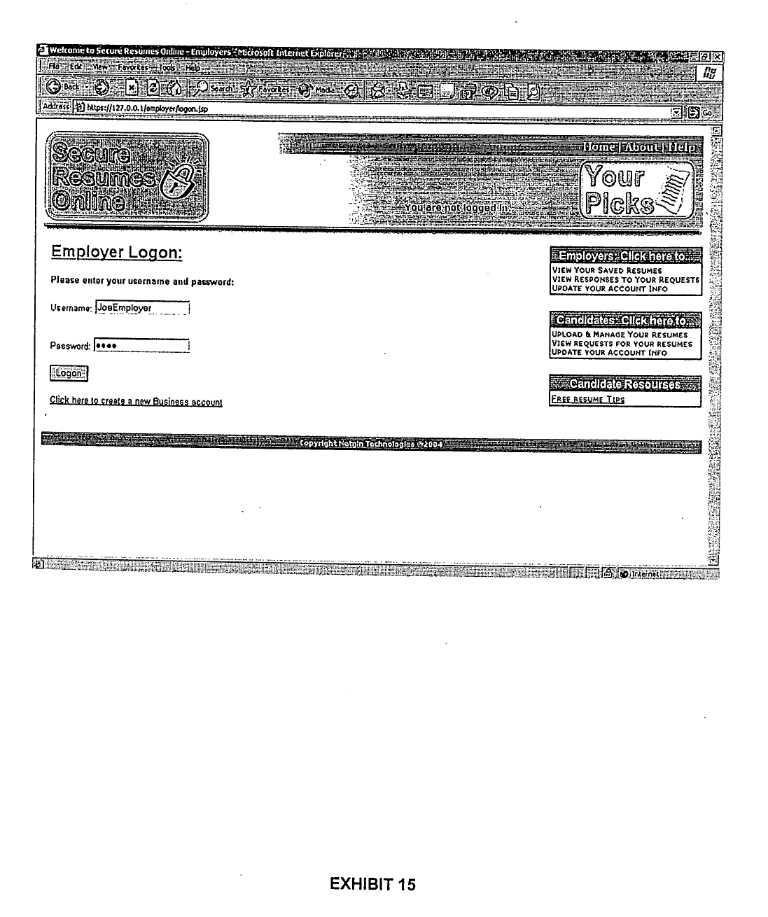

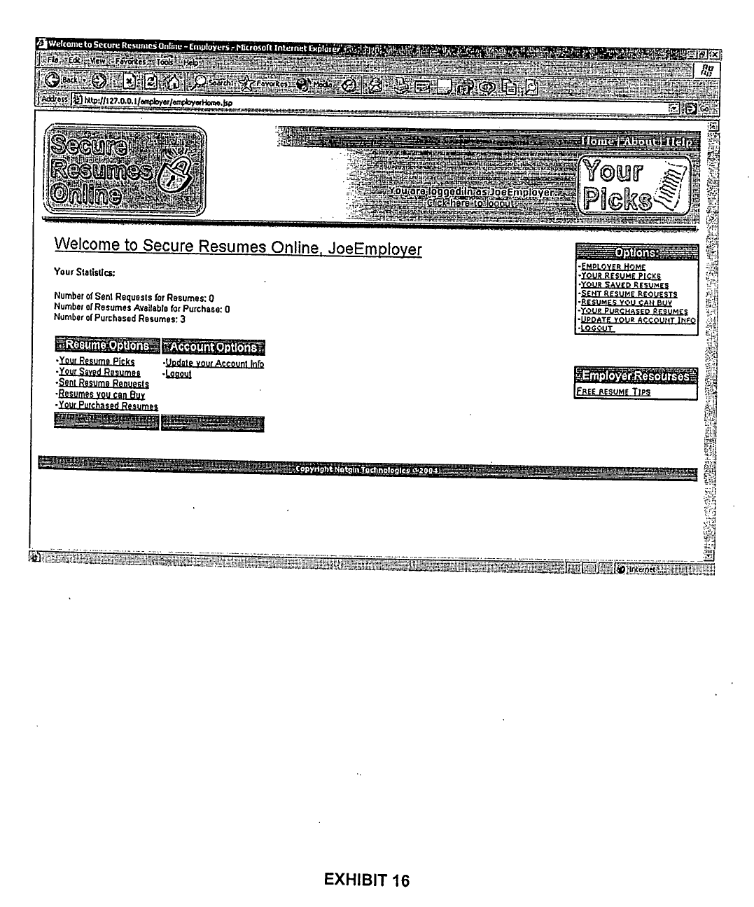

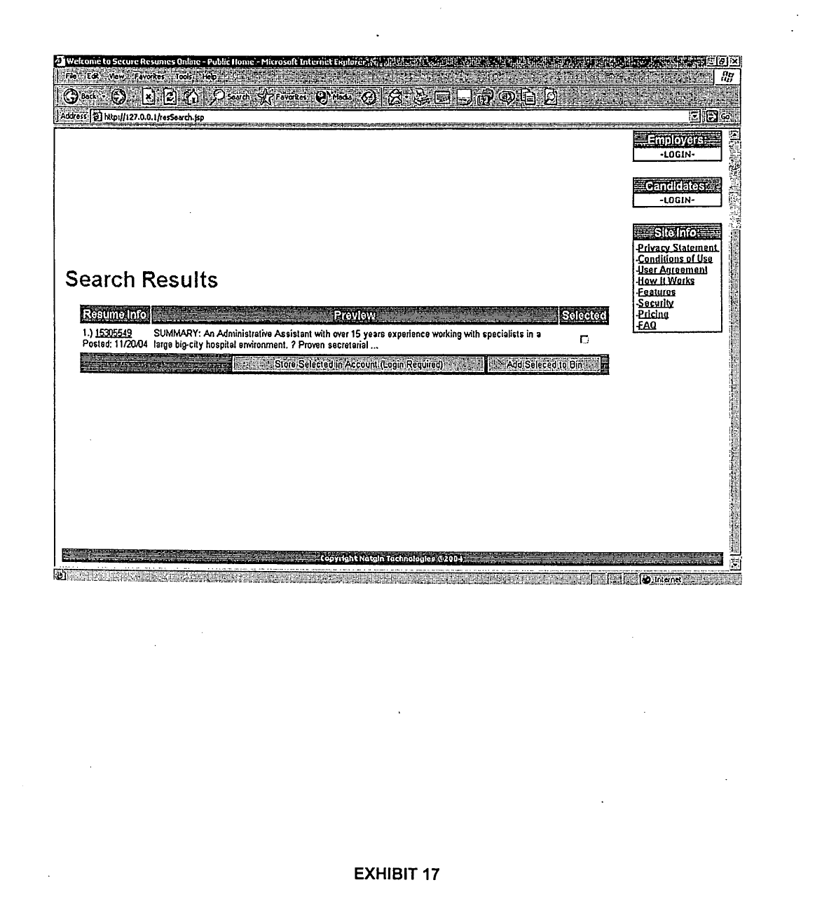

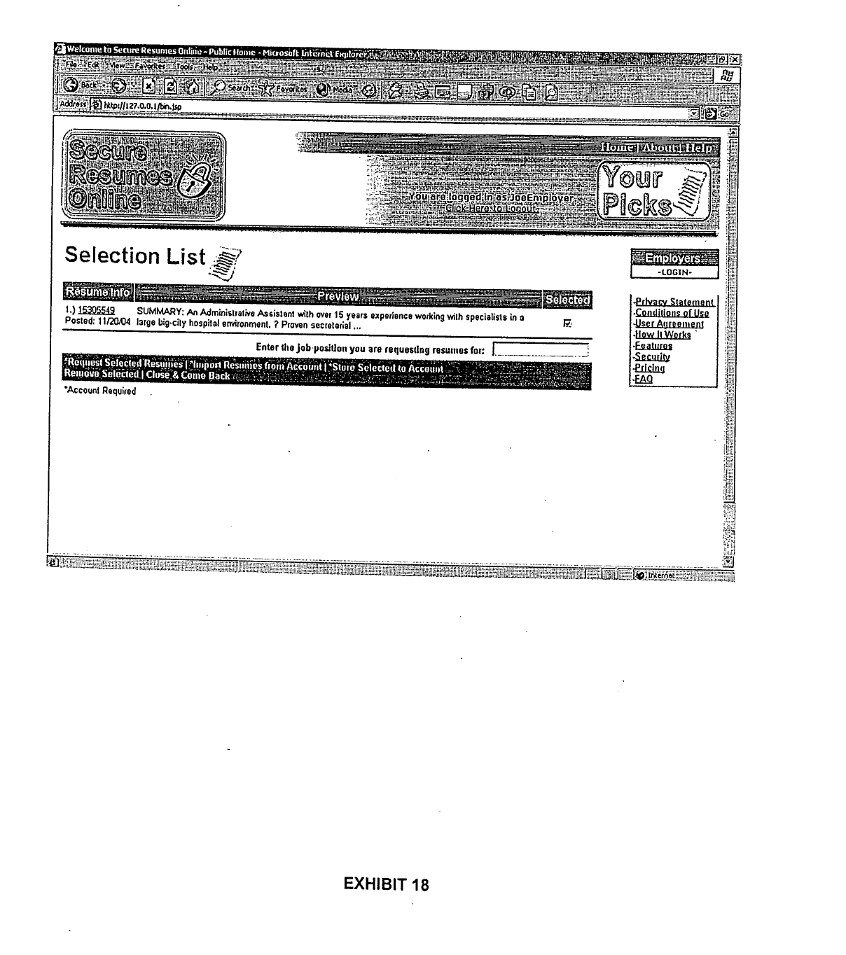

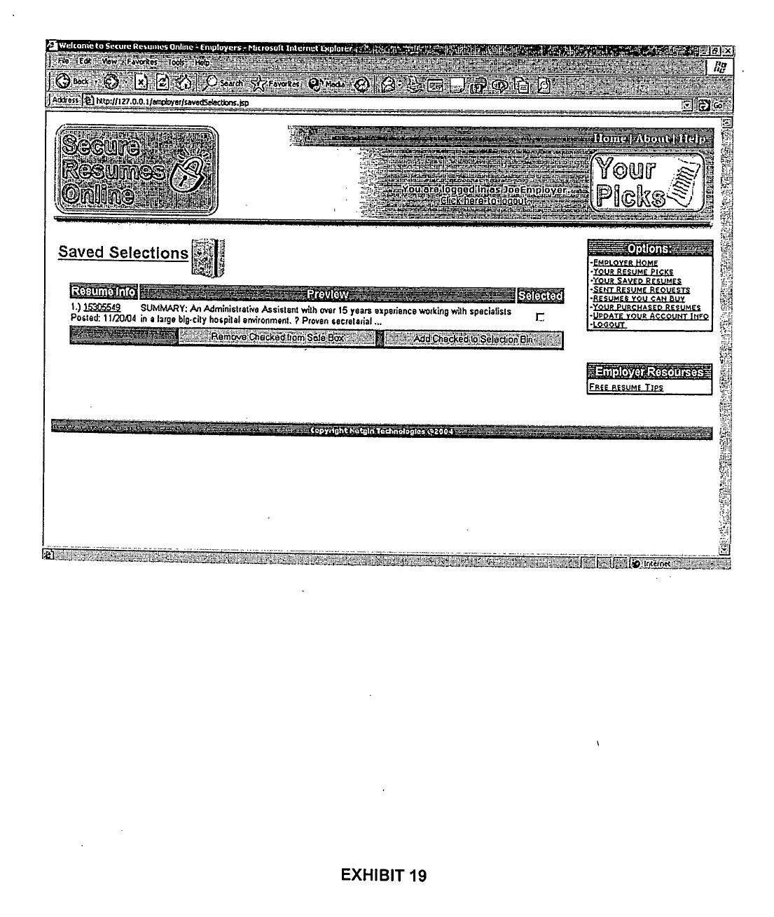

Third, the four patents listed above only allow employers to see the search results on the pre-designed summary of the resume outline form which is similar to the paper forms widely in use by current employment agencies. This is depicted in U.S. Pat. No. 6,713,345 as FIGS. 5. As in the paper forms, the contact information is left out until the employer agrees to payment. It does not release the image of the complete resume until after payment is made. In contrast, the current invention allows the employer to see an image of the actual resume with the contact information electronically rendered indecipherable, even before payment. Therefore, in the current invention, the employer can experience the “look and feel” of the original resume without being able to view the contact information PRIOR to paying any fee. The prior art did not anticipate this. The prior art keeps the resume image hidden until payment (or promise of payment) is received.

Forth, in the four patents listed above, the image of the resume is stored “intact”, that is, there are no modifications made to the image. In the current invention, a method is provided for the job candidate to electronically “blur out” the confidential information contained on the stored image of the resume over the Internet. The prior art did not anticipate this feature.

Fifth, the prior art did not anticipate sending the job candidate a list of the companies interested in viewing the unmasked resume PRIOR to releasing the contact information. This is necessary to prevent the current employer or other undesirable companies from obtaining the unmasked version of the resume. In contrast, the current invention allows the job candidate to control which companies are able to see his/her resume on a case-by-case basis in real time while the prior art has no provision to allow this.

Sixth, the above listed patents send the employer (after payment) a graphic image of the resume and the contact information. The current invention sends the employer (after payment) the actual resume configured in PDF format, a widely used text format, not a graphic image. This is usually a much smaller file size and has better definition than a graphic image and facilitates the storage and printing of the resume by the employer since most black-and-white printers handle text far better than images.

Seventh, in the above listed patents, the job candidate needs to convert and upload his resume to the server in the form of a graphics file where it is stored. It is very explicit in that it be a graphics file in the form of a .GIF, .TIF, .JPG, .BMP, .TGA, .EPS, .PCS or any other form of a graphics file where it is stored on the server. The patents state that the job candidate typically uses a scanner or fax machine to create the graphics file but could also send a paper copy of the resume to the system administrator who will perform the conversion to a graphics file. The requirement to convert it to a graphics file can become a burden to someone who does not have access to a scanner or fax. Also, there is no easy way to go directly from a text file to a graphics file within most industry-standard word processing programs. Therefore, eliminating the requirement for the job candidate to convert it to a graphics file is a big improvement in facilitating the uploading of a resume for storage on a server. In the current invention, there is no requirement that the resume be uploaded in the form of a graphics file (a mandatory requirement in the four pre-referenced patents) as the resume is uploaded in the form of an industry standard RTF text file (in the preferred embodiment) and not a graphics file. The invention can also be made to work with any other industry standard text file format.

Problems with the Prior Art

Unfortunately, despite their good intentions, the prior art has not realized it's full potential due to a number of factors which are based in technological limitations. This has stifled the increased use of this valuable resource (the Internet) in the dissemination of resumes to potential employers.

The problems we see with the current technology are listed as follows:

First, even though most of the current resume listing services capture the basic information associated with listing a resume, they tend to be inaccurate and unreliable much of the time. Many of the resumes are “stale” having been left on the services for a considerable amount of time without being updated. In addition, some of the resumes are downright fraudulent or frivolous since most resume sites currently exercise little to no control over the origin of the resume.

Second, the mechanisms that are used to capture supplementary information about resumes over the Internet are often cumbersome to use and tedious. For example, if the listing service wishes to record a searchable index of the candidate's skills along with each resume, the job candidate would manually have to type this information into a textbox for submission. Currently, with the prior art, there is no fast way to extract this kind of information from an uploaded resume. This is an important point.

Third, in recent times, identity theft has become a major problem. The U.S. Government is well aware of this growing problem and has recently begun warning the public about the dangers of identity theft. Unprotected resumes placed on the Internet have the potential of providing an unscrupulous path the ability of intercepting confidential information and using it to set up a false identity. As is result, recent news reports and some employment consultants have been advising their clients to avoid placing any personal information on the Internet. Therefore, many people have now abandoned the Internet as a medium to list an unprotected resume. This is stifling the growth of the Internet as a medium for the listing of resumes.

Forth, most Internet resume listing services utilize a business model generally used by most employment agencies that charge the employers the majority of the fees necessary to cover operating costs. This has resulted in employers having to pay relatively large non-refundable sums of money ($300 to $600) solely for the privilege of looking at the resumes featured in the site for some predetermined length of time, (e.g. one month, three months, etc.) or for a predetermined number of resumes. This discourages small businesses who, in general, are reluctant to spend a great deal of money on any service that does not guarantee results. For example, an employer that pays for the service in advance but is unable to find any promising resumes would be discouraged from using that service in the future. This has the effect of stifling the growth of the Internet as a medium for the searching of resumes.

Fifth, job candidates who are asked to email their resume directly to a company are now discovering that current Spam Elimination Programs are also deleting resumes without warning because they are unable to distinguish between legitimate resumes and undesired Spam. Companies have reportedly lost many desired resumes this way so the current practice of emailing resumes as an attachment is now being viewed as unreliable and discouraged.

Sixth, practically all resume listing websites restrict access to the resumes from casual observers. They accomplish this by either denying access completely to non-employers or require the observer to sign in. These sign-in requirements, even if free, are often time-consuming and tedious and may require the observer to release information that they are unwilling to share on the Internet. This discourages potential employers from using the resume listing service and limits it's usefulness and universality. Job candidates WANT their resumes seen by potential employers and if employers are not looking at the website it defeats the whole purpose of listing their resume which leads ultimately to less people listing their resumes which leads less employers using the service and so on.

Seventh, the current online resume listing services do not provide a way for the job candidates to prevent employers and other business concerns from viewing their private contact information without their prior permission on an individual case-by-case basis. Candidates that post their resume online tend to get bombarded with frequent mass job offerings that are fraudulent, frivolous, or do not pertain to the candidate. For instance, any telemarketing company that pays the typical fees for the online service immediately has access to a myriad of contacts. The firm could then send out bulk job offerings to a multitude of people. Also, there is no way with the prior art to prevent a job candidate's current employer from viewing his or hers posted resume if the employer used a different name or division to gain access to the resumes.

It is apparent that the prior art has not anticipated all the features and improvements that are contained in the current invention. It is obvious that the new invention would provide a service that would become highly desirable and useful to both the job candidate (resume owner) and to the employer seeking to fill a position. It is therefore the object of this invention to provide a method and apparatus of listing resumes on the Intermet that avoids all of the problems listed previously and offers a higher degree of security and utility than is currently possible with the present state of the art.

### SUMMARY OF THE INVENTION

This invention describes a new and novel way of storing and displaying a collection of resumes on a public computer network (such as the Internet) in such a manner that the look-and-feel of the original resume is maintained while keeping the candidates identity hidden until the candidate gives authorization on a case-by-case basis to release the contact information over the same Internet link.

### OBJECTIVE

The primary purpose of this invention is to make it as easy as possible for job candidates to upload their resumes to a resume listing service, make these resumes available to potential employers over an Internet link with the least amount of hassle to the employer, and minimizing or eliminating the possibility of identity theft. It is also an objective of this invention to provide employers with a searchable database of actual resumes where the “look and feel” of the original resume is preserved. The result of this technology is that the Job Candidate would have much better exposure in the job market without compromising his personal security thus increasing his chances of a job offer.

Features

The primary features of this new technology are as follows:
(1) Makes listed resumes available to everyone on the Internet in a secure manner.
(2) Maintains the confidentiality of tie job candidate's personal information.
(3) Maintains the “look and feel” of the original listed resumes.
(4) Permits employers to browse for resumes without any pre-registration or up-front payment thus encouraging participation from employers and increasing the success rate for job candidates.
(5) Contains a searchable database that works off the original resume (not text boxes or a pre-designed form) to narrow down the search to particular key words.
(6) Provides a method to obtain approval from the resume owner over the Internet on a case-by-case basis prior to the release of any confidential or contact information.
(7) Prevents the release of the job candidate's identity to current employers or companies he does not want to do business with by providing the job candidate a method to disapprove those companies.
(8) Limits the viewing of individual resumes to geographical areas specified by the job candidate thus increasing security.
(9) Prevents the listing of fraudulent and frivolous resumes by use of a fee structure.
(10) Prevents the listing of stale resumes (i.e. more than 6 months old).
(11) Prevents the resume owner from including contact information within his listed resume by use of proprietary embedded software.
(12) Releases the unmasked version of the resume containing the contact information only after receiving payment of a nominal fee from the employer (assuming the job candidate has given permission for this particular employer).
(13) Prevents anti-Spam software from deleting or blocking the resume by allowing the employer to download the un-masked actual resume directly from the Internet after appropriate conditions are met. This is done by providing notification to the employer upon receiving permission from the job candidate by use of the Internet connection. This avoids having to email the actual resume as an attachment which is subject to possible blocking by anti-Spam software.
(14) Provides the job candidate the ability to create multiple resumes to target different industries.
(15) Provides a way for employers to browse through thousands of resumes without having to worry about picking up a computer virus or waiting for people to send the resumes in.

### DETAILED DESCRIPTION OF THE INVENTION

The best way to describe how the invention remedies the issues described above is to divide the functionalities of the site into two perspectives: the Job Candidate's Perspective, and the Employer's Perspective.

1.0 Job Candidate's Perspective

1.1 Account Creation
The first task that the job candidate must complete is to create an account. This is necessary to prevent frivolous or fraudulent resumes from being submitted. The account creation process requires the candidate to enter in some basic information like username, password, email address, as well as some demographic information such as the candidate's zip code, the regions in which he wishes to find employment, and a choice regarding relocation options. If the job candidate desires, the account can be anonymous as we have no need or desire to know his/her identity to make the web site functional.
More specifically, the candidate is presented with a list (or drop-down menu) of geographical regions from the entire nation (i.e. Southern New Jersey, Metro New York, etc.) where he wishes to obtain employment. These do not need to be related to his current residence. He can choose as many regions as he deems necessary. These regions will be used as criteria in the employer's search for resumes.
The candidate is also presented with three choices concerning relocation: he can specify not to relocate at all, to relocate only if the relocation expenses are paid by the employer, or to consider relocation unconditionally (that is, he pays his own relocation expenses).
1.2 Account Funding & Expiration
The candidate may also be required to find his account in order for his resumes to be available to employers. This is accomplished via a simple subscription renewal interface. The subscription generally will cost a small nominal fee (e.g. $5 to $10) and last for a specified term length (e.g. 3 to 6 months) although in some cases the fee could be waived, for instance, during special promotions. The payment process will interface directly with PAYPAL to complete the transaction. The candidate will be required to have a PAYPAL account or (in an alternative version a valid credit card) to successfully find his account.
Note that the candidate will still have the option of fully utilizing the site to upload and manage resumes, etc. without funding his account. However, none of his resumes would be viewable by the public. If the candidate's account expires, the account would still be usable but all of his resumes would be hidden from the public until the account is funded again. The candidate will be sent a reminder email when the account expiration date is approaching.
The idea of charging a small fee to the candidate to list resumes is uncommon among present day online resume listing services. Traditionally, candidates are able to list their resumes online for free and the employer is charged to view them. We have strayed away from the traditional model in order to ensure that the resumes listed in the database remain reasonably current and are not frivolous or fraudulent. By applying a subscription to the candidate's account, we are able to prevent expired resumes from being displayed to employers. Even if the candidate finds a job but is negligent in removing the resumes for searching, a common problem, they will eventually expire. Applying a small fee to list a resume also discourages fraudulent resumes simply because it would become too expensive for the offender. In general, the fee would be small enough not to be a financial burden on the candidate, but large enough to prevent mass uploads from Spam brokers.
1.3 Managing Resumes
After the candidate's account has been created, he can then start to manage his resumes. Before employers can view a resume, it has to be uploaded, initialized, and categorized. Candidates also have the basic ability to preview, delete, and hide their resumes.
1.4 Uploading the Resume
The resume uploading process is simple. The job candidate is instructed to save his resume in Rich Text Format (RTF) format. This is easily done within any word processing application. The candidate is then prompted with an HTML data entry interface to browse to the resume file (which normally resides on the candidate's hard drive) on the client's computer. The candidate then clicks the button and the resume begins to upload.
It is important that the resume file be first converted to Rich Text Format (RTF). RTF is a universal file format that is used by every major word processing program (i.e. MS Word, Claris Works, Lotus, etc.). We impose this restriction on the file format (in the preferred embodiment) to make the system as universal as possible. Windows, Linux, and Mac users can easily save their resumes in RTF with even the most basic word processing programs. Therefore, use of this application is not limited to any particular computer or operating system.
However, although the type of the format specified in the preferred embodiment of the invention is RTF, it would be obvious to anyone skilled in the art to recognize that other text-based formats such as can be generated by Microsoft Word, Notepad, WordPad, HTML, WordPerfect, Claris Works, Lotus, Word for Macintosh, Works for Windows, Adobe, etc., resulting in file extensions such as but not limited to: .doc, .txt, .htm, .dot, .asc, .ans, .mcw, .wps, .pdf, or any other text-based format would work equally well and could just as easily be used without departing from the spirit and functionality of the invention.
During the upload process, the resume RTF file is scanned for viruses. It is also converted into other file formats (e.g. PDF) for distribution and for the initialization applet described below. If there are no errors during this process, the candidate can move on to initialize and categorize the resume. Otherwise, if there are errors, he will have to upload the resume again. Note that it is NOT necessary for the job candidate to upload or supply the server with a graphic image of the resume. This is one area where the current invention differs from the prior art.
1.5 Initializing the Resume
After the resume is successfully uploaded, the candidate can go on to initialize the resume. Initializing the resume requires the candidate to first define the sections of the resume (i.e. Contact Info, Objective, Skills, Experience, etc.), and then select out the corresponding text of the resume for each of the defined sections with a Graphical User Interface (GUI). The candidate has the ability to choose which of the defined sections are to be hidden from the public. However, the contact information is required to be hidden.
The GUI is comprised of a proprietary java applet which was custom written for this application that uses a copy of the resume generated from the RTF file that is uploaded. This copy will preserve almost all of the look and feel of the candidate's resume but prevents anyone from hacking or modifying it. The candidate will select out the sections of the resume by clicking and dragging on this picture, which would highlight the respective sections in different colors. (Note that we expect to get a separate patent for this.)
After the sections are defined and all of the text in the resume is highlighted, the site will process the sections and generate a searchable text list to be stored in the database. This will serve as a base of keywords to be used as criteria for the employers when they search for resumes. Note that this information comes directly off the actual resume and does not require the job candidate to fill out any forms or text boxes. This is another important area where the current invention differs from the prior art.
Note that any section that is not hidden will be automatically scanned for contact information and other illegal material. If any illegal material is found, then the initialization process will not succeed and the candidate will be sent an error message.
At this time, the site will also generate a new copy of the resume that has all the hidden sections of resume blurred out and completely unreadable. It will be these secure copies of the candidate's resume that will be available to the public. Because this is a secure copy of the resume rather than the actual text version, it will be impossible to hack into to modify or retrieve out the sections rendered indecipherable. This is an important part of this invention. Employers will be able to browse through these secure copies free of charge and decide if they wish to further pursue that candidate.
The candidate also needs to categorize the resume before it can be made available to employers. The candidate will be presented with a list or a drop-down menu of common job categories, job functions, and experience levels that can be saved along with each resume. For example, the resume could fall into the automotive industry, floor sales position, and entry-level experience. The site will allow each resume to be associated with any number of these combinations.
The candidate will accomplish this via an industry standard web data entry interface. Employers will use the categories that are applied to each resume as search criteria. This will allow employers to narrow their search significantly.
1.7 Managing Requests From Employers
After the resume is uploaded, initialized, categorized, and made available on the World Wide Web (Internet), employers will begin to browse the resume. Eventually, an employer who views the resume will be interested in the job candidate and want to contact him. He will do this by submitting a request (via the website) to view the entire resume, including the hidden sections like the contact information. Note that the public version of the resume has all the contact information blurred out so it would be impossible for anyone to know who the job candidate was. Note also that the website does not release contact information directly or separately as this information is already contained on the unmasked version of the resume so there is no need to store this as a separate field, thus, security is enhanced. This is another important area where the current invention differs from the prior art.
The candidate is then presented a list of these requests from within his account on the website and is optionally emailed a reminder when new requests arrive. That is, the job candidate will have the option of receiving an email reminder or just login to his account to see if there are any new requests. Each list items will display the request date, the name of the requesting company, the location of the job (if it is at different location than the parent company), and the resume ID that is requested, as well as a link to view the resume that is requested.
An important part of this invention is that at this point, the candidate can either approve or deny any request at will. This allows him to hide his identity from his current employer, and other companies he does not want to do business with, on a case-by-case basis. The prior art has not anticipated this feature and current resume listing sites do not have this ability.
To prevent abuse of this process, each employer can only request a particular resume once during a particular time period, for example, a thirty-day period. This would prevent the same employer requesting the same resume over and over again.
If the candidate approves the request, the employer will be given an opportunity to acquire the full version of the resume. If the candidate denies the requests the employer will be sent all appropriate notification of the denial. This will enable the candidate to protect the confidential sections of his resume regardless of whether or not the employer is a paying customer of the resume listing service. This is an important feature of this invention and we are not aware of any other online resume listing service that provides this degree of selective confidentiality.
   2.0 Employer Perspective
2.1 Searching for Resumes
An important and key feature of this invention is that an employer (or anyone for that matter) is able to search for resumes and view resumes without having to first log in, pre-register, or pay any up front fees. This is a revolutionary concept. For the first time ever there is a way to publish real resumes on the Internet while preserving their owners confidentiality. By keeping it simple and easy, we hope to encourage the greatest participation possible.
The search page is presented as the starting point of the site. This encourages the employer to start searching for resumes right away thus increasing the participation rate. The possible criteria for a resume search include the geographical region where the employer offers a job or jobs, the geographical region where the job candidate desires to work, the job category, job function, experience level, and any possible keywords that the resume contains.
Note that it is not necessary for the employer to know the job candidate's address because that information is irrelevant at this point. For instance, the job candidate may currently live in New Jersey, but plans to relocate to California at some future date. Or alternately, the job candidate may be interested in relocating anywhere in the U.S. The questions about relocation for the job candidate and the employer deal with these issues. Note that this is another area where the current invention differs from the prior art. That is, the job candidate's address does not enter into the search equation.
2.2 Search Criteria
The employer first chooses the regions to search (i.e. Southern New Jersey, Metro New York, etc.). This is done by selecting the successive state, and region from the list box, and adding it to the search parameters. There is also an option concerning relocation. The employer may include job candidates from outside the chosen regions that are willing to relocate at their own expense or are willing to relocate conditional on the employer's willingness to pay expenses. This is accomplished by a single click in a check box or radio selection button.
The second criterion consists of the job categories for each resume. The employer is presented with a familiar list of all the possible job categories, job functions within each category, and experience levels for each function. This is accomplished by making the appropriate selections within a set of list boxes or pull-down menus. Again, he can add as many categories to search as necessary.
The third criterion is the keyword search. The employer can filter results based upon keywords that the resume contains. The employer enters a set of words separated by spaces to filter on. He can choose whether or not to return resumes that contain all of the words specified or resumes that contain any one or more of the words specified.
These three main criteria provide a powerful tool to narrow down searches that would normally return a large number of unwanted results.
2.3 Search Results
After the search criteria are entered and the web form is submitted, a list of resumes is displayed. Each list item displays the resume ID (a random number assigned to each resume by the application) with a link to view the secured (masked) version of that, resume, as well as the date the resume was submitted, and a preview of the text contained in that resume. A check box is also provided next to each resume. This allows the employer to select a large number of resumes at once. There are two buttons provided: one adds the checked resumes to the Selection List (described below), and the other adds them to the Safe Box (described below).
2.4 The Selection List
The Selection List holds all of the resumes that the employer is planning to request. Here, the employer can send requests for resumes, remove resumes from the selections list, or import resumes from the Safe Box (see below). Each list item displays the resume ID (a random number assigned to each resume) with a link to view the secured (masked) version of that resume, as well as the date the resume was submitted, and a preview of the text contained in that resume. A check box is also provided next to each resume. The check boxes provide a way for the employer to request, or move a large number of resumes at once.
When the employer chooses to request the unmasked version of one or more resumes on the selection list, he is first required to log in (see account creation below). Note that he does not have to log in to view secure resumes (which have contact information blurred out), only to request to view the original un-masked version of them. Once the employer's account is verified, a request will be generated and sent to the candidate. At this time, the resume is removed from the selection bin and placed in the “Manage Sent Requests” area (see below).
Note that the Selection List is kept on the employer's computer and is not stored to his account on the server computer. Therefore, when the employer moves to another machine, the Selection List will be unavailable. The reasons for doing it this way are to conserve server memory and to avoid storing thousands of lists that are obsolete or inactive.
However, we have also provided a way for the employer to make his selection list available on other computers. In order to do this, the employer must move the resumes from his Selection List to the Safe Box under his account where he can access them from any computer attached to the Internet. (described below)
2.5 Account Creation
Before the employer can request or purchase un-masked resumes, he is required to create an account. Be does not have to create an account to view secure resumes (i.e. which have contact information blurred out), only to purchase them.
Account creation is simple. The employer is prompted to enter in some required information like username, password, email, company name, location, etc. To keep things simple, the employer is not required to make or agree to any payment at this time.
2.6 The Safe Box
The Safe Box provides the employer with a way to save potential resumes to his personal account, rather than to the Selection List which is stored on the client's personal computer. In this way, he can access them from any computer attached to the Internet. In contrast, the Selection List would be unavailable on any computer other than the client's personal computer.
The Safe Box mimics the Selection List in every way except when requesting resumes. The employer cannot request resumes directly from the Safe Box. However, the employer has the ability to export the saved resumes directly to the Selection List. The employer also has the ability to add and delete resumes from the Safe Box. To conserve server memory, any Safe Box which is not accessed after a pre-determined period (90 days, for instance) will be cleared out automatically.
2.7 Managing Sent Requests
Once a resume is requested from the selection list, a record of that request is archived for the employer. The employer is presented with a two lists of requests. The first list displays the resumes that are currently waiting for approval by their respective candidates. This list displays the resume ID, the date it was requested, and a text preview of the resume. The employer also has the option of canceling a pending request. Pending requests that are older than some period of time such as thirty days are automatically denied. This is to avoid allowing the employer to request an obsolete or withdrawn resume.
The second list displays a list of denied requests. Once a candidate denies a request, that request will remain in the denied request list for that respective employer for some period of time such as thirty or ninety days. During that time, the employer will NOT be able to send another request for that same resume. This is a precaution that will prevent abuse of the listing service.
If the request if approved by the candidate, the request record is removed from the pending request list, and the resume is listed in the available for purchase list. (see below)
2.8 Purchasing Approved Resumes
Once a request is approved, the corresponding resume will be listed in the approved resumes section. Here the employer sees a familiar list consisting of each resume's ID, post date, text preview, and a check box. The use of check boxes makes it easy for the employer to manage and purchase a large number of resumes at once.
Once the employer selects one or more resumes with the check boxes and clicks the purchase button, the site will create all invoice and tally up the amount for the order. The employer will be redirected to PAYPAL along with the invoice where he can finalize payment. Once payment is verified, PAYPAL will send a real time notification to the website that the payment was completed. At this time, the site will transfer the corresponding resumes from the order the download purchased resumes area.
Note that all the transactions happen in almost real time that is, almost immediately. However, there may be a few seconds delay between the payment interfaces.
Note also that PAYPAL is only used for convenience and any other form of payment such as credit cards or other web-based payment methods could have just as easily been used without departing from the functionality and spirit of the invention.
After payment is verified, the employer should see the purchased resumes in the Download Resumes area. This area is simply a list of each resume with the resume ID, posted date, text preview and a link to download the full, uncut version of the resume.
Once the employer clicks on the download link, he is provided with a universal PDF file version of the full resume. A PDF File is used because it is a universal standard available across many platforms and operating systems and is easy to download, easy to save in a computer database and prints out reliably on most printers. Also, a PDF file is not modifiable without special software enhancing the security of the resume.
However, in other embodiments of the invention, it would be obvious to anyone skilled in the art that it would be just as easy to store the original document in anther text-based format such as but not limited to .doc, .mcw, or .txt, however, this in no way departs from the functionality and spirit of the invention.
Note that it is the employer's responsibility to download the purchased resume to his computer where he can print it out or store it for future reference. The resume is not emailed to him thus avoiding being eliminated by anti-Spam software.
   Other Uses:

Although the included examples and much of the description has been centered around resumes, the technology could equally well be used for resume cover letters, financial reports, medical reports, bank account statements, stock quotes, benefit plans, news articles, technical articles, service bulletins, book reviews, maps, charts, or any other application which requires a searchable database and where the “look and feel” of the document is desired to be preserved without revealing certain portions of the document to unauthorized persons. Another use for this invention would be for the listing of jobs in the case where the employer desired to maintain his identify confidential. In this case, the roles of the employer and the job candidate would be reversed such that the employer would be posting a job and the job candidate would be contacting the employer for his identity and the employer could decide who to release his identity to by accepting or denying the request.

In summary, the present invention provides substantial assistance to both employers and job candidates:
(1) Employers: A method and apparatus for providing employers with a searchable database of resumes over an Internet link which maintains the “look and feel” of the original resume while rendering the confidential parts of the resume indecipherable and providing the employer with the ability to request the unmasked version of one or more of said resumes over the same link.
   a. Method of providing employers with a searchable database of resumes while maintaining the “look and feel” of the original resume with confidential parts rendered indecipherable and impossible to hack into.
   b. Method of providing employers with the ability to request one or more unmasked versions of a resume (which are normally displayed over the Internet with the confidential parts rendered indecipherable) by simply clicking on a check box or radio button within a web page.
(2) Job Candidates: A method and apparatus for providing job candidates with a web page application that contains a list of employers interested in contacting the candidate and subsequently receiving from the job candidate an approval or denial to release to the said employer(s) the unmasked version of the same resume which contains certain confidential information (such as contact information) that is normally hidden from the public over an Internet link.
   a. Method of notifying a job candidate the names of employers interested in viewing his unmasked resume over an Internet link prior to the release of the same resume.
   b. Method of receiving approval or denial from a job candidate to release confidential information contained in a resume displayed on the Internet.
   c. Method of receiving approval or denial from a job candidate to release confidential information contained in a resume displayed on the Internet by clicking on a check box or a radio button.

To aid in the understanding of the present invention, the following list of definitions and Appendix of exhibits are provided and incorporated to illustrate the best embodiment of the invention:

### DEFINITIONS

(1) www World Wide Web
(2) RTF Rich Text Format
(3) HTML HyperText Markup Language
(4) PDF Portable Document Format (Adobe Systems Inc. Format)
(5) SVG Scalable Vector Graphics
(6) GUI Graphical User Interface
(7) PAYPAL An Internet based payment service.
(8) XML Extensible Markup Language
(9) OF Formatting Object
(10) Plug-In A very small program that adds a specific feature to a web browser.
(11) Applet A program that is designed to run inside of a larger program and perform a specific function for the larger program.

(12) Cookies Very short web-based strings of text that hold certain types of information for future use like user name, ID number, etc. Note that there is no limitation on the length of cookies although they are generally less than 50 characters long.

### APPENDIX OF EXHIBITS

Exhibits

(1) Block diagram of typical system.
(2) Flow chart from Job Candidate's perspective
   a. Main
   b. Account Creation
   c. Funding the Account
   d. Manage Resume Page
   e. Uploading a Resume
   f. Initializing a Resume
   g. Categorizing a Resume
   h. Managing Requests From Employers
(3) Flow chart from Employer's perspective
   a. Searching for Resume
   b. Log On & Account Creation
   c. Selection List
   d. Employer's Home Page
   e. Safe Box
   f. Managing Sent Requests
   g. Purchasing Resumes
   h. Downloading Purchased Resumes
(4) Image of blurred out sample resume (pages 4a and 4b)
(5) Image of same resume as above but without masking (pages 5a and 5b)
(6) Image of Web Site Home Page. (pages 6a and 6b)
(7) Image of Job Candidate's login screen
(8) Image of Job Candidate's Create Resume Sections screen
(9) Image of Initialize Resume screen
(10) Image of Job Candidate Account Creation screen (pages 10a and 10b)
(11) Image of Resume Control Center screen.
(12) Image of Statistics screen.
(13) Image of Approve Resumes screen.
(14) Image of Create Employer Account screen.
(15) Image of Employer's Login screen.
(16) Image of Employer Welcome screen.
(17) Image of Employer's Search Results screen.
(18) Image of Employer's Selection List screen.
(19) Image of Employer's Safe Box screen.

The following programs which are the subject of the identified copyright registrations are incorporated in their entirety by reference:
Copyright Registration No. TXu-1-219-281 “Applet Defining a Web-based Method of Rendering Indecipherable Selected Parts of a Document and Creating a Searchable Database from the Text”, registered Jan. 3, 2005; AND
Copyright Registration No. TXu-1-219-282 “Method of Displaying a Resume Over the Internet in a Secure Manner,” registered Jan. 3, 2005.

While the invention has been described with regard to a preferred embodiment, i.e. one in which the job candidate loads his resume into the facilitator's server in Rich Text Format, there is also significant advantage to having the program adapted so that the job candidate may load the resume in any of the other common word processing document formats, for example, Microsoft Word, Clarice Works, WordPerfect, Lotus, and the like, with MS-Word being of particular significance because of its prevalence among computer users. These common word processing document formats can be converted into XML format or PDF format by any one or more of the readily available “tools” adapted to run the major platforms. These “tools” include OpenOffice, AbiWord, Antenna House Server-based Converter V1.2, Microsoft Windows, GNU/Linux, Sun Solaris, Mac OS X, or “Free BSD.” These various programs will permit conversion of the uploaded resume into either XML format or PDF format, which can then be converted into SVG format. Accordingly, the invention should not be considered to be limited to the use of the standard RTF text file format.

What is claimed:

1. A method for seeking employment on the internet involving a job candidate, a potential employer, and a facilitator comprising the steps as follow:
A. The job candidate loads an appropriate resume to the facilitator's server in a word-processing document format convertible into XML or PDF format.
B. The job candidate defines the sections of the resume and selects out text for each of the defined sections with a graphical user interface;
C. The facilitator then processes the sections and generates a searchable text list to be stored in the server data base;
D. The facilitator then generates a new copy of the resume in which the selected sections for hiding have been rendered unreadable;
E. The facilitator then makes available for searching on the internet the secure copy of the resume, rather than the original actual text version;
F. A potential employer searching the internet who finds a job candidate of potential interest submits a request by way of the web site to view the entire resume including the hidden sections;
G. The facilitator notifies the job candidate of the requests from potential employers for determination of interest by the job candidate;
H. The job candidate notifies the facilitator of those potential employer requests of interest and those that are not of interest;
I. The facilitator then provides the potential employers the opportunity to acquire the full version of the job candidate's resume in those cases where approval has been received from the job candidate.

2. A method for seeking employment on the internet involving a job candidate, a potential employer, and a facilitator comprising the steps as follow:
A. The job candidate loads an appropriate resume to the facilitator's server in Rich Text format.
B. The job candidate defines the sections of the resume and selects out text for each of the defined sections with a graphical user interface;
C. The facilitator then processes the sections and generates a searchable text list to be stored in the server data base;
D. The facilitator then generates a new copy of the resume in which the selected sections for hiding have been rendered unreadable;
E. The facilitator then makes available for searching on the internet the secure copy of the resume, rather than the original actual text version;
F. A potential employer searching the internet who finds a job candidate of potential interest submits a request by way of the web site to view the entire resume including the hidden sections;
G. The facilitator notifies the job candidate of the requests from potential employers for determination of interest by the job candidate;
H. The job candidate notifies the facilitator of those potential employer requests of interest and those that are not of interest;
I. The facilitator then provides the potential employers the opportunity to acquire the full version of the job candidate's resume in those cases where approval has been received from the job candidate.
